(19) United States
(12) Patent Application Publication
(10) Pub. No.: US 2024/0070786 A1
(43) Pub. Date: Feb. 29, 2024

(54) Systems and Methods to Facilitate Increased Building of Renewable Energy Infrastructures

(71) Applicant: ParseHill Renewables, LLC, The Woodlands, TX (US)

(72) Inventor: Ethan Joseph Novek, Houston, TX (US)

(73) Assignee: ParseHill Renewables, LLC, The Woodlands, TX (US)

(21) Appl. No.: 18/217,204

(22) Filed: Jun. 30, 2023

Related U.S. Application Data
(60) Provisional application No. 63/446,558, filed on Feb. 17, 2023.
(60) Provisional application No. 63/400,260, filed on Aug. 23, 2022.

(51) Int. Cl. G06Q 40/06; G06Q 50/06

(52) U.S. Cl. CPC G06Q 40/06; G06Q 50/06

(57) ABSTRACT

An investment company, acting as a guarantor of a purchase price for power to be produced by a renewable energy facility, issues a plurality of shares on a private or public financial exchange, and obtains capital from the issuance of the shares. At least a majority portion of the capital is held as collateral for the investment company's future obligations as the guarantor of the purchase price for power to be produced by the renewable energy facility. A computing system of the investment company hosts a browser accessible application and services for the shareholders, e.g., to track cash distributions and/or renewable energy certificate (REC) distributions by the investment company to the shareholders. The browser accessible application and services of the computing system further allow shareholders to input a selection to receive REC distributions or cash equivalent REC distributions from the investment company.

### COPYRIGHT NOTICE

A portion of the disclosure of this patent document contains material which is or may be subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### CROSS-REFERENCE TO RELATED APPLICATIONS

This application claims the benefit of the U.S. provisional patent application entitled “Renewable SPGC,” having Ser. No. 63/446,558, filed Feb. 17, 2023, and also claims the benefit of the U.S. provisional patent application entitled “Systems and Methods for Providing Secondary Market Access to Power Purchase Agreements,” having Ser. No. 63/400,260, filed Aug. 23, 2022, which are hereby incorporated by reference in their entirety as if fully set forth herein.

### BACKGROUND OF THE INVENTION

A renewable energy certificate (“REC”) represents clean and/or renewable energy attributes from a renewable energy system and are typically bundled in minimum denominations of one megawatt/hour of electricity. A REC is separate from the value of the 1 Megawatt/hr of electricity itself and permits the owner or purchaser to claim the benefits of the clean or renewable energy production by effectively subsidizing the cost of the renewable energy systems. Electricity may enter a public electrical grid from many different sources, ranging from wind and solar power to natural gas and nuclear power. Because of this, there is no certain method to determine the source of electricity delivered from the public electrical grid to a particular customer. To solve this problem, RECs may be purchased or delivered along with or separately from the electricity. RECs are certificates that transfer the “renewable” aspects of renewable energy to the owner. In other words, renewable energy credits, paired with electricity from the electrical grid, are provable renewable energy.

RECs may be purchased in advance of the production of the electricity to provide an economic incentive to invest in renewable energy systems. The additional income received from selling RECs in advance increases the economic value of an investment in renewable energies. Instead of up-front subsidies from the state, owners of renewable energy systems may recover at least part of the investment in the renewable energy system by selling the RECs.

Once the renewable energy system is active and producing electricity, to issue the RECs, the renewable energy system must first be certified by state regulatory agencies, usually public service commissions or public utility commissions. Once a renewable energy system is certified with the state agency, RECs can be issued using either an estimate table or actual meter readings of the produced electricity depending upon state regulations. In some cases, smaller installations may be able to use estimates, while actual meter readings are required for large installations.

RECs can also be a commodity traded in compliance markets in states that have Renewable Portfolio Standards (RPS) programs. In these markets, electric distribution companies and electric generation suppliers acquire a certain threshold of RECs to meet state compliance. The REC owner can advertise their RECs on an Attribute Tracking Bulletin Board, check a Buyer's Bulletin Board for specific purchase requests for RECs, work with an aggregator or broker to either purchase the RECs directly, or to assist the REC owner in finding a buyer. The REC owner may also use an auction or exchange platform to sell RECs.

Virtual power purchase agreements (“VPPAs”) are any type of agreement between an owner or developer of an existing or to be developed renewable energy system (“System Owner”) and a guarantor (“Guarantor”) that insures or guarantees a purchase price of future produced electricity (“Guaranteed Price”). A significant portion of development of renewable energy systems is financed through VPPAs which help to facilitate building of renewable energy infrastructures. VPPAs may comprise a fixed-for-floating swap contract or contract-for-difference contract, wherein the VPPA Guarantor guarantees a purchase price for future electricity produced by the renewable energy system when the price received for the electricity in the marketplace (“Market Price”) is below the Guaranteed Price.

The Guaranteed Price may be a pre-defined price or may be a predefined price-range with respect to a base or floor price (“Floor Price”), e.g., wherein the Floor Price may be $0 or $5 per MWh. Historically, some solar PV and onshore wind projects have been unable to fully capture the average prevailing marketplace electricity price due to power transmission bottlenecks and/or producing power when market prices are low. In some parts of the United States, when wind and/or solar are plentiful and power demand is low, the price of electricity on a marketplace may drop to $0 per MWh, or, in some cases, negative electricity prices, which may be costly for a Guarantor in a VPPA. As such, in some embodiments, VPPAs are structured with a Price Floor, e.g., $0 per MWh, preventing exposure to negative electricity prices.

When the Market Price is less than the Guaranteed Price, the Guarantor guarantees to pay a difference between the Guaranteed Price and either the Market Price or the Floor Price, whichever is higher. The Guarantor thus assumes the floating price risk associated with future produced electricity at market prices on a local electricity marketplace.

Unlike trading markets for RECs, there is no current efficient system or method for transferring, in whole or in part, the risk or position of the Guarantor and/or the transfer of the VPPA. Such a transfer of the VPPA risk or position is currently inefficient, and/or inaccessible, and/or non-liquid, and/or non-transparent. Thus, there is a need for improved systems and methods for public access to invest in renewable energy infrastructures through VPPAs.

### BRIEF SUMMARY OF THE INVENTION

In one aspect, a method of a computing system for an investment company includes processing shareholder information stored in at least one system memory device of the computing system to determine a number of shares of the investment company, wherein the investment company acts a guarantor of a guaranteed price per power unit of renewable energy produced by a third party renewable energy facility. The method further includes determining, by the computing system, a total number of renewable energy credits (RECs) obtained during a settlement period from the renewable energy facility, wherein each REC is generated for one power unit produced and delivered to an electrical grid by the renewable energy facility. The method further includes determining, by the computing system, any settlement income for the settlement period, using a number of a plurality of power units produced by the renewable energy facility during the settlement period, the guaranteed price for the plurality of power units of renewable energy, and a market price received by the renewable energy facility for the plurality of power units. The method further includes determining, by the computing system, a shareholder distribution of the settlement income using the determined settlement income and the number of shares of the investment company, and determining, by the computing system, a shareholder distribution of the total number of RECs using the total number of RECs and the number of shares of the investment company.

In another aspect, a computing system of a guarantor company includes at least one system memory and at least one processing unit, wherein the processing unit is operatively coupled to the at least one system memory and wherein the at least one system memory stores instructions that, when executed by the at least one processing circuit, configures the computing system to determine a total number of renewable energy credits (RECs) obtained by the guarantor company during a settlement period from a renewable energy facility, wherein each REC is generated for one power unit produced and delivered to an electrical grid by the renewable energy facility. The computer system is further configured to generate a graphical user interface (GUI) for display on one or more shareholder devices, wherein the GUI includes at least one user input configured to set a shareholder preference to receive RECs as shareholder distribution from the guarantor company or to receive a cash distribution for the RECs as the shareholder distribution from the guarantor company. The computer system is further configured to obtain from a first shareholder device a first election by one of a plurality of shareholders to receive RECs as the shareholder distribution from the investment company and determine a number of REC(s) allocated for distribution to the one of the plurality of shareholders using the total number of RECs, a total number of a plurality of shares of the guarantor company, and a number of shares owned by the one of the plurality of shareholders. The computer system is further configured to obtain from a second shareholder a second election by a second one of the plurality of shareholders to receive a cash distribution for the RECs as the shareholder distribution from the investment company and determine the cash distribution for the RECs to the second one of the plurality of shareholders using a price per REC and a number of REC(s) allocated for distribution to the second one of the plurality of shareholders.

In another aspect, a method of a computing system for an exchange traded fund (ETF includes determining, by the computing system, a total number of shares for each of a plurality of guarantor companies that are held by the ETF, wherein a majority of the assets of the ETF include the shares for each of the plurality of guarantor companies and determining, by the computing system, a total number of renewable energy credits (RECs) obtained by the ETF as shareholder distributions from the plurality of guarantor companies, wherein each REC is generated for one power unit produced and delivered to an electrical grid by a renewable energy facility. The method further comprises determining, by the computing system, a plurality of shareholders of the ETF by accessing a shareholder database in at least one system memory device of the computing system and generating, by the computing system, a graphical user interface (GUI) for display on one or more shareholder devices, wherein the GUI includes at least one user input for selecting at least one of a plurality of elections, wherein the plurality of elections includes at least a first election for receiving RECs as shareholder distribution from the guarantor company and a second election for receiving a cash distribution for the RECs as the shareholder distribution from the guarantor company. The computer system further comprises processing, by the computing system, a first election received from a browser of a first shareholder device and store the first election in a first data field associated with a first one of the plurality of shareholders in the shareholder database; and determining, by the computing system, a number of REC(s) allocated for distribution to the first one of the plurality of shareholders using at least the total number of RECs, a total number of shares of the ETF, and a number of shares owned by the first one of the plurality of shareholders. The method further includes in response to the first election, generating, by the computing system, a distribution of the number of REC(s) allocated for distribution to the one of the plurality of shareholders.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. To illustrate embodiments, there is shown in the drawings example and/or preferred embodiments. It should be understood, however, that the invention as claimed is not limited to the embodiments, examples, arrangements and instrumentalities shown in the drawings.

The subject application references certain processes which are presented as a series of ordered steps. The steps described with respect to these processes are not to be understood as enumerated consecutive lists but could be performed in various orders while still embodying the invention described herein.

Where a term is provided in the singular, the inventors also contemplate aspects of the invention described by the plural of that term. As used in this specification and in the appended claims, the singular forms “a”, “an” and “the” include plural references unless the context clearly dictates otherwise, e.g., “an appliance” may include a plurality of appliances. Thus, for example, a reference to “a method” includes one or more methods, and/or steps of the type described herein and/or which will become apparent to those persons skilled in the art upon reading this disclosure.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods, constructs, and materials are now described. All publications mentioned herein are incorporated herein by reference in their entirety. Where there are discrepancies in terms and definitions used in references that are incorporated by reference, the terms used in this application shall have the definitions given herein.

FIG. 1 depicts a schematic block diagram of a currently known system for a VPPA arrangement, including a renewable energy facility and a guarantor company.

FIG. 2 depicts a schematic block diagram of an improved system for a guarantor company in accordance with one or more embodiments herein.

FIG. 3 depicts a schematic block diagram of an exemplary network environment in accordance with one or more embodiments herein.

FIG. 4 depicts a schematic block diagram of an exemplary device, server and/or memory device in accordance with one or more embodiments herein.

FIG. 5 depicts a schematic block diagram illustrating a formation process of a special purpose guarantor company (“SPGC”) in accordance with one or more embodiments herein.

FIG. 6A depicts a schematic block diagram of an exemplary result for an SPGC at the end of a first settlement period in accordance with one or more embodiments herein.

FIG. 6B depicts a schematic block diagram of another exemplary result for an SPGC at the end of a first settlement period in accordance with one or more embodiments herein.

FIG. 7A depicts a flow chart of an exemplary method for formation of an SPGC in accordance with one or more embodiments herein.

FIG. 7B depicts a flow chart of another exemplary method for formation of an SPGC in accordance with one or more embodiments herein.

FIG. 8A depicts a flow chart of an exemplary method for determining the capital requirements of an SPGC in accordance with one or more embodiments herein.

FIG. 8B depicts a graph of an example of potential investment income from collateral held by the SPGC in accordance with one or more embodiments herein.

FIG. 9A depicts a flow chart of an exemplary method for shareholder distributions of RECs by a SPGC in accordance with one or more embodiments herein.

FIG. 9B depicts a flow chart of an exemplary method for determination of settlement income by a SPGC in accordance with one or more embodiments herein.

FIG. 9C depicts a flow chart of an exemplary method for determination of a distribution of settlement income by a SPGC system in accordance with one or more embodiments herein.

FIG. 9D depicts a flow chart of an exemplary method for determination of distribution of RECs, or cash equivalent thereof, for shareholders of a SPGC in accordance with one or more embodiments herein.

FIG. 10 depicts a schematic block diagram of an exemplary system for an investment fund (IF) in accordance with one or more embodiments herein.

FIG. 11A depicts a flow chart of an exemplary method for formation of an investment fund in accordance with one or more embodiments herein.

FIG. 11B depicts a flow chart of an exemplary method for shareholder distributions by an investment fund in accordance with one or more embodiments herein.

FIG. 12 depicts a schematic block diagram of an exemplary graphical user interface (“GUI”) on a display in accordance with one or more embodiments herein.

FIG. 13 depicts a schematic block diagram of another exemplary GUI on a display in accordance with one or more embodiments herein.

FIG. 14 depicts a schematic block diagram of another exemplary GUI on a display in accordance with one or more embodiments herein.

FIG. 15 depicts a schematic block diagram of another exemplary GUI on a display in accordance with one or more embodiments herein.

FIG. 16 depicts a schematic block diagram of an exemplary shareholder application (“SA”) system in accordance with one or more embodiments herein.

FIG. 17 depicts a schematic block diagram of another exemplary system for an investment fund (IF) in accordance with one or more embodiments herein.

FIG. 18 depicts a schematic block diagram of an exemplary GUI on a display in accordance with one or more embodiments herein.

FIG. 19 depicts a schematic block diagram of another exemplary GUI on a display in accordance with one or more embodiments herein.

FIG. 20A depicts a flow chart of an exemplary method for identification of RECs using input REC parameters in accordance with one or more embodiments herein.

FIG. 20B depicts a flow chart of an exemplary method for determination of a share position in accordance with one or more embodiments herein.

FIG. 21 depicts a schematic block diagram of an exemplary REC management tool implemented in the shareholder application (“SA”) system in accordance with one or more embodiments herein.

FIG. 22 illustrates a schematic block diagram of an exemplary SPGC for investing in the production, or manufacture, or distribution, or infrastructure of copper in accordance with one or more embodiments herein.

### DETAILED DESCRIPTION OF THE INVENTION

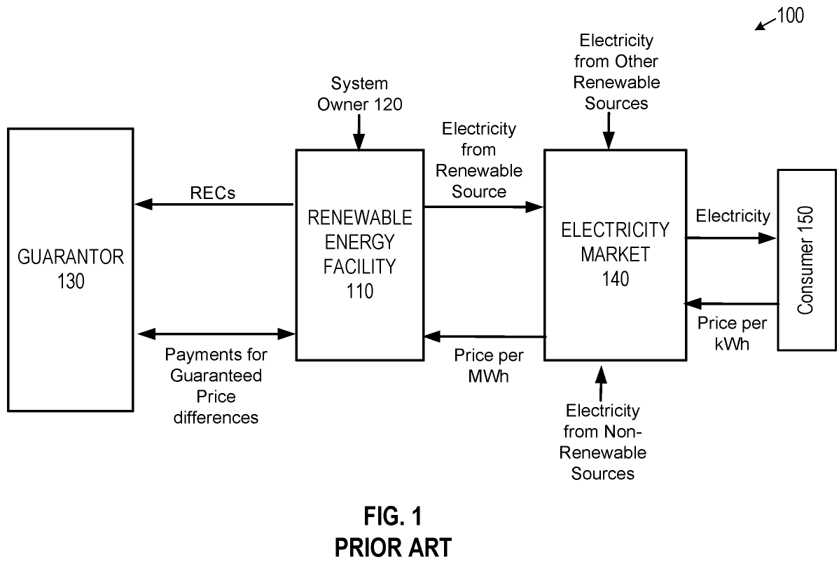

FIG. 1 depicts a schematic block diagram of a currently known system for a VPPA arrangement 100, including a renewable energy facility 110 and guarantor 130. The renewable energy facility 110 includes a plant that generates power, such as electricity, using one or more sustainable resources. Sustainable resources are resources that can be constantly replenished, such as, solar, wind, thermal, heat, geothermal (e.g., heat of the earth, temperature differences in the oceans), biomass (e.g., plant materials), hydro (e.g., currents, falling water), or tidal (energy of the tides). These sustainable sources are endless and will not run out, as opposed to non-renewable sources, such as fossil fuels (oil, coal, natural gas) or nuclear energy. The renewable energy facility 110 includes a corporation, company, partnership, proprietorship, doing business as (DBA), or other legal entity or individual with an ownership stake in a renewable energy facility 110, or that may operate, or may develop, or may represent a renewable energy facility 110 and may also be referred to herein as the System Owner 120.

The Guarantor 130 includes a corporation, company, partnership, proprietorship, doing business as (DBA), or other legal entity or individual that assumes a price risk exposure of future generated power from the renewable energy facility 110. The Guarantor 130 and the System Owner 120 may enter into a virtual power purchase agreement or other similar type of contractual agreement, promissory note, or purchase (referred to herein as a “VPPA”). As part of the VPPA, the Guarantor 130 guarantees that at least a minimum compensation will be received by the System Owner 120 for future generated units of power from the renewable energy facility. For example, the VPPA may state that the Guarantor 130 guarantees a fixed price, or a price range, for 1 megawatt per hour (MWh) of future generated electricity (referred to herein as the “Guaranteed Price”). In some embodiments, the Guaranteed Price in the VPPA may include one or more or any combination of the following: minimum price limits, price floors, price collars, non-zero price flows, or indexed linked pricing.

The electricity market 140 may include a public utility operating an electrical grid or a private electrical grid or company with extensive power needs or other entity that purchases electricity in exchange for compensation and provides the electricity to a private institution or to the public. In general, the electricity market 140 purchases electricity in units of MWh from a plurality of sources, e.g., from the renewable energy facility 110, non-renewable sources, such as fossil fuel electrical plants, or from other renewable energy facilities. The electricity market 140 may resell the electricity to one or more public or private consumers 150, usually in kilowatts/hour (kWh).

In this known arrangement of FIG. 1, the Guarantor 140 enters into a VPPA with the System Owner 120 to invest in development of the renewable energy facility 110 or future production of the renewable energy facility 110. The VPPA in general includes a contract or agreement wherein the Guarantor 130 assumes at least a portion of the market price risk and/or wherein the System Owner 120 receives a guarantee of a consistent price or price range, e.g., the Guaranteed Price, for the power to be produced by the renewable energy facility 110. The VPPA reduces market price risk for the System Owner 120 but may also potentially limit market price upside for the System Owner 120. In a VPPA, the Guarantor 130 assumes some market price risk, however, the Guarantor 130 may have at least a portion of the price upside.

For example, under common VPPA terms, when the electricity produced by the renewable energy facility 110 of the System Owner 120 is sold at a price per MWh on the electricity marketplace 140 (hereinafter referred to as the “Market Price”) which is greater than the Guaranteed Price, the System Owner 120 pays the Guarantor 130 the difference between the Market Price and the Guaranteed Price. In other words, the Guarantor 130 makes money when the power produced by the renewable energy facility 110 is sold on the marketplace at a higher Market Price than the Guaranteed Price. The Market Price may be determined by the actual price paid or owed for each MWh of electricity or by an average price or mean price paid or owed for the electricity. When the electricity produced by the renewable energy facility 110 is sold at a Market Price which is less than the Guaranteed Price, the Guarantor 130 pays the System Owner 120 the difference between the Guaranteed Price and the Marketplace Price.

In some VPPA terms, the Guarantor 130 may also receive production tax credits, or Renewable Energy Certificates (RECs), or Investment Tax Credits (ITC), or other certificates, credits, tax incentives, or any combination thereof from the System Owner 120. The Guarantor 130 may choose to hold the RECs, or sell the RECs, or any combination thereof. Many Guarantors 130 in VPPAs are large electric power consumers, such as industrial companies or companies operating data centers. These Guarantors 130 may enter into VPPAs, for example, to hedge power price exposure, or to make renewable energy claims, or to achieve renewable energy targets.

This prior art VPPA arrangement 100 has many disadvantages, as described herein. First, System Owners 120 of renewable energy projects under development generally need VPPAs in place to receive capital loans from banks for the planning, development, construction, commissioning, and/or expansion of a renewable energy facility 110. The cost of these capital loans significantly influences the price of the power and whether the project will be economically viable. The cost of capital, such as the charged interest rate, may be significantly influenced by the credit risk or credit rating of the Guarantor 130 in the VPPA. However, many companies who enter into a VPPA or want to enter into a VPPA have a non-perfect credit rating, which may increase the potential cost of capital, and/or increase the price of the power from the renewable energy project.

In another disadvantage of the prior art VPPA arrangements, the prior art processes for transferring the risk or position of the Guarantor 130, e.g., transfer of the VPPA, may be inefficient, or inaccessible, or non-liquid, or non-transparent. For example, in prior art, VPPAs are non-transferable and non-exchangeable. So, the position of the Guarantor 130 in a VPPA is generally a permanent, or non-exchangeable, or difficult-to-exchange, or difficult-to-transfer position because, for example, the financing of the project may be based on the creditworthiness of the Guarantor(s), and it may be difficult to exchange the creditworthiness of one entity with the creditworthiness of another entity. As such, a Guarantor 130 may have difficulty selling, transferring, or off-loading its VPPA obligations, if desired. Thus, the high difficulty to exchange or transfer the Guarantor position may mean illiquidity or low liquidity, which may result in significant market inefficiency and price dislocation. It may also deter entities from assuming the position of Guarantor.

In another disadvantage, the number of qualified Guarantors with high credit ratings and sufficient capital may be limited, which may inhibit renewable energy project development. This may lead project developers into entering into potentially unfavorable or unprofitable VPPA terms.

In another disadvantage of prior art VPPA arrangements 100, VPPAs are non-transparent. The terms of some VPPAs are non-public, which may result in unforeseen risks to electricity consumers and/or may facilitate corporate dishonesty about financial contributions or commitments to renewable energy.

Another example of a disadvantage, VPPAs may have a high transaction cost. Entering into a VPPA as a Guarantor 130 requires extensive due diligence, negotiation, and contract drafting. Successfully navigating the process requires significant in-house power market experience, financial resources, and time. Companies wanting to enter into a VPPA may need to hire legal teams, investment banks, consultants, and power procurement personnel to manage the process.

In yet another disadvantage of prior art VPPA arrangements 100, the Guarantor position of a VPPA is inaccessible to the public. The position of a Guarantor 130 in a VPPA is generally unavailable or inaccessible to the public despite its significant value as an investment, usefulness as an inflation hedge, and relatively low risk profile. In prior art, the position of a Guarantor 130 is generally only available to large, high credit rated companies, or institutions, or municipalities. As such, being a Guarantor 130 is generally unavailable to smaller entities and/or lower credit rated entities, or individuals, because, for example, prior art VPPAs may require the Guarantor 130 to assume the credit risk of guaranteeing the price in a VPPA.

Another disadvantage, in prior art, are that VPPAs are non-diversified and usually only apply to a single renewable energy project. This lack of inherent diversification may result in significant exposure to the performance of a single project or sole sourcing risk. For example, a single project may have abnormally lower-than-anticipated electricity market prices, or abnormally lower-than-anticipated project power production, or any combination thereof, when compared to other similar projects. Even in VPPAs with multiple entities as Guarantors 130, each Guarantor 130 may be required to assume a significant portion of the VPPA obligations and risks.

The cost of solar and wind power has decreased tremendously. Currently, many new solar and wind projects have an unsubsidized levelized cost of power less than fossil fuel power generation. For example, the average unsubsidized levelized cost of electricity from utility scale solar PV and onshore wind in many parts of the United States is less than the average industrial price of electricity. Additionally, in recent years, many solar photovoltaic (“PV”) projects have been constructed and commissioned with financing based on Guaranteed Prices in VPPAs that are significantly lower than the average industrial price of electricity. In some electricity markets and locations, there is a significant spread in price between the average market price of electricity on a power marketplace and the Guaranteed Price in VPPAs, which may result in cashflow positive VPPAs and/or profitable VPPAs for Guarantors 130. Thus, more companies and individuals may be motivated to participate in a Guarantor position of a VPPA. As such, in one or more embodiments, systems and methods are described herein that enable a public secondary market to participate as a Guarantor 130 and/or enable the transferability of the Guarantor position in a current VPPA. This secondary market helps to increase investment in renewable energy and facilitate increased building of renewable energy infrastructures.

### Embodiment of an SPGC

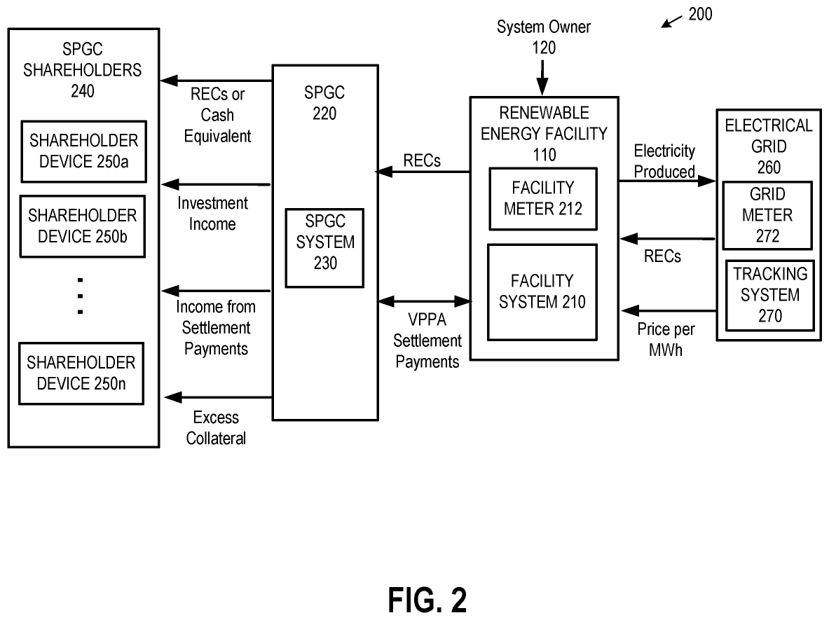

FIG. 2 depicts a schematic block diagram of an improved system 200 for a guarantor company. In one or more embodiments herein, a Special Purpose Guarantor Company (“SPGC”) 220 is formed that includes a corporation, company, or other legal entity that functions or acts as a Guarantor of a Guaranteed Price of future generated power of a renewable energy facility 110 and issues a plurality of shares that may be publicly listed on a stock exchange or on a private exchange. The SPGC 220 may hold capital or collateral sufficient to cover the cost of potential future obligations as a Guarantor under a VPPA with a renewable energy facility 110. The SPGC 220 may generate income from the spread between the Market Price of the power units sold by the renewable energy facility 110 and the Guaranteed Price of the power units in the VPPA.

In addition, as part of the terms of the VPPA, the SPGC 220 may receive RECs for power produced by the renewable energy facility 110 and may distribute at least a portion of the RECs to the SPGC shareholders 240. For example, when the renewable energy facility 110 generates a unit of electricity, such as 1 MWh, a facility meter 212 generates a notification to the facility system 210. The 1 MWh of produced electricity may then be delivered to a public utility electric grid 260 that includes a tracking system 270 for generating and managing RECs. The tracking system 270 generates a unique REC for each 1 MWh of electricity produced by the renewable energy facility and counted by the grid meter 272.

Certificate tracking systems, such as tracking system 270, account for RECs and ensure that RECs are only held by one organization. These tracking systems 270 are typically electronic databases that register basic information about each megawatt-hour (“MWh”) of renewable power generation in a specific U.S. geographical region. The certificate tracking systems 270 issue RECs to the renewable power generator, e.g., the renewable energy facility 110, signifying that a 1 MWh of renewable electricity has been delivered to the grid 260. The tracking systems assign a unique identifier to each REC to ensure that only one REC is issued for each 1 MWh of power, to avoid ownership disputes and minimize double issuance. As such, a uniquely identified REC can only be in one tracking system account (i.e., owned by one account holder) at a time. The tracking system 270 may also include one or more of the following data attributes to a REC: certificate type, tracking system ID, renewable fuel type, renewable facility location, nameplate capacity of project, project name, emissions rate of the renewable resource, date issued, time issued, etc. This list is not exhaustive and additional or alternate data attributes may be included with the REC.

Tracking systems 270 are emerging as the preferable method for tracking wholesale renewable energy because they can be highly automated and provide reliable, specific information for each REC. In addition, the REC database of the tracking system is accessible over the Internet to market participants, such as the SPGC 220. The current owner of the REC may easily assign or otherwise transfer title of an REC in its account to an account of another party, e.g., by accessing the tracking system 270.

In operation, a REC is issued automatically by the tracking system 270 for each one megawatt-hour (MWh) of electricity produced by the renewable energy facility 100 and delivered to the electrical grid 260 or otherwise counted by the grid meter 272. The facility system 210 stores the REC and the Market Price received for the 1 MWh of power. The RECs described herein include any government approved legal instruments, or certificates supported by regional electricity authorities, non-governmental organizations, or trade associations and/or any other market-based instrument that represents a property right to the environmental, social, and/or other non-power attributes of renewable electricity generation. For example, the RECs described herein, may include Renewable Thermal Certificates (RTCs), issued for renewable thermal energy, or other types of certificates for other types of renewable energy projects.

In general, the VPPA pre-designates a predetermined settlement period for determining settlement payments. For example, a settlement period may be, including, but not limited to, one of the following: 1 day, 1 week, 1 month, 3 months, 6 months, or 1 year. The total number of settlement periods in a VPPA is determined by the duration or term of the VPPA divided by the duration of the settlement period. For example, if a VPPA designates a settlement period of 1 month, and the term of the VPPA is 20 years, then the VPPA has a total of 240 settlement periods.

At the end of a settlement period, the facility system 210 and/or SPGC system 230 determines a settlement payment. The renewable energy facility system 210 determines the units of power produced during the settlement period and the Market Price of any sold units of power, e.g., the Market Price received for 1 MWh of electricity. The settlement payment is determined from a difference between the Market Price and the Guaranteed Price in the applicable VPPA and the number of units of power produced during the settlement period. For example, the facility system 210 may determine that 200,000 MWh of electricity were produced and sold for an average Market Price of $60 per MWh. The facility system 210 then determines the Guaranteed Price under the VPPA is $50 per MWh and the difference between the Market Price and the Guaranteed Price is $10 per MWh. The facility system 210 multiplies this $10 per MWh difference by the 200,000 MWh of power produced during the settlement period. In this example, the renewable energy facility must pay to the SPGC 220 the settlement payment of $2,000,000 for the settlement period.

In another example calculation, let n designate a number of MWh of electricity generated under a VPPA. The facility system 210 may determine the settlement payment from the following summation.

$${\sum }_{MWh = 1}^{MWh = n} Guaranteed Price of MWh - Market Price of nth MWh$$

The facility system 210 may transmit to the SPGC system 230 an accounting of the settlement payment for the settlement period and the agreed upon number of RECs. The facility system 210 may also transmit additional data, such as the Market Price per nth MWh, the unique identifiers of the RECs, the readings from the facility meter 212 and/or the grid meter 272, etc. The facility system 210 may also arrange for the settlement payment to be transferred to an agreed upon bank account associated with the SPGC system 230. The facility system 210 may also transmit to the tracking system 270, a request to change the title or owner of the 20,000 RECs from the renewable energy facility 110 to the SPGC 220.

In another example, when the Guaranteed Price is greater than the Market Price, the facility system 210 requests the settlement payment for the settlement period from the SPGC system 230. In response, the SPGC system 230 may verify the calculation of the settlement payment and/or initiate transfer of the settlement payment to an agreed upon bank account associated with the renewable energy facility 110.

### SPGC Distributions to Shareholders

In some embodiments, when the SPGC 220 receives settlement payments for a settlement period (e.g., when the Market Price was greater than the Guaranteed Price), the payments may be designated as settlement income and distributed to the SPGC shareholders 240, for example, as a dividend distribution. For example, in some embodiments, an SPGC system 220 may determine a distribution of settlement income during a settlement period, in accordance with the following calculation:

$$\frac{Settlement Income - Withholding}{Number of SPGC Shares Outstanding} = Settlement Income per SPGC Share$$

The withholding may include fees for distribution, management, or other costs or fees. The SPGC system 220 may thus determine the settlement income per SPGC share from the one or more settlement payments received during the settlement period and the number of SPGC shares. For example, the SPGC 220 may receive $912,500 in settlement income during a settlement period, and the SPGC 220 may deduct withholdings of $30,000 for expenses or fees and may distribute the net proceeds or net income of $882,500 to, e.g., 1,000,000 outstanding SPGC shares, for a monthly distribution of $0.8825 per SPGC share. This settlement income distribution provides shareholders access to the potential income of a Guarantor position in a VPPA while at least partially isolating the shareholders from the long-term commitments and liabilities of the Guarantor position in a VPPA.

However, the SPGC 220 may designate distribution periods that are different than the settlement periods. For example, the distribution to SPGC shareholders 240 may be scheduled quarterly or yearly while the settlement period may be 1 day, 1 week, 1 month, etc. The settlement payments received during the distribution period may then be used to determine the settlement income in the calculation. For example, when a settlement period is monthly under a VPPA and the distribution period for the SPGC is quarterly, the settlement income includes the three monthly settlement payments for each of the three settlement periods. Withholdings, such as management or other fees and/or capital withholding, may be deducted from the settlement income for the distribution period. The settlement income less any withholdings is then divided by the number of SPGC shares outstanding to obtain the settlement income for distribution per SPGC share during the distribution period.

In some embodiments, RECs generated and provided to the SPGC 220 as a part of a VPPA may be distributed to SPGC shareholders 240. In some embodiments, RECs generated and provided to the SPGC 220 as a part of a VPPA may be sold and/or the net proceeds from the sale of generated RECs may be distributed to SPGC shareholders 240. In some embodiments, a shareholder 240 of the SPGC 220 may elect to receive generated RECs directly or indirectly or elect to receive the net proceeds from the sale of RECs, or any combination thereof related to or associated with the number of shares or percentage ownership of the SPGC 220. For example, the SPGC 220 may receive RECs under the terms of a VPPA from the renewable energy facility 110, divide the received RECs by the number of SPGC shares outstanding, and distribute RECs or fractions of RECs to shareholders on a per share held by a shareholder basis or based on the percentage of ownership of the SPGC 220 held by a shareholder. For example, in some embodiments, SPGCs 220 may distribute RECs, or fractions of a REC, or other credits generated by a VPPA, or any combination thereof on a per share basis or proportional to the ownership of the SPGC 220 held by each shareholder.

For example, in some embodiments, an SPGC system 220 may determine a distribution of RECs, or fractional RECs, to shareholders, in accordance with the following calculation:

$$\frac{RECs}{Number of SPGC Shares Outstanding} = RECs per SPGC Share$$

In a specific example, if the SPGC 220 receives 200,000 RECs from a renewable energy facility 110 under a VPPA, and the SPGC 220 has 1,000,000 shares outstanding, then the SPGC system 230 may determine the REC(s) per SPGC share for distribution using the following calculation.

$$\frac{200 , 000 RECs}{1 , 000 , 000 SPGC Shares Outstanding} = 0.2 RECs per SPGC share$$

For example, if the SPGC 220 receives an average of 200,000 RECs per settlement period from a renewable energy facility 110 under a VPPA, and each settlement period is 1 month, and the SPGC has 1,000,000 shares outstanding, then the SPGC system 230 determines a rolling 12-month REC yield of the SPGC 220, e.g., using the following calculation.

$$\frac{( 200 , 000 MWh of RECs ) * 12}{1 , 000 , 000 SPGC Shares Outstanding} = 2.4 RECs per SPGC Share per year$$

In some embodiments, an SPGC 220 may distribute the RECs to shareholders less withholdings of any REC fees, commissions, costs, deductions, etc. The REC withholdings may include, e.g., fees to change ownership with the tracking system 270, costs for tracking the RECs until transfer to the shareholder 240, or other processing fees. The SPGC system 230 would then determine the RECs distributed, e.g., using the following calculation.

$$\frac{( Total RECs for Distribution - Withholding )}{Number of SPGC Shares Outstanding} = RECs per SPGC Share for Distribution$$

In some embodiments, the SPGC 220 may provide a centralized platform for REC management and REC compliance. In some embodiments, RECs may be tokenized. In some embodiments, the RECs may be transferred to the shareholder's accounts in one or more tracking systems 270 associated with each electricity grid operator system or Renewable Portfolio Standard (RPS) commodity market or compliance market of the RECs elected for distribution by the shareholder.

In another example, in some embodiments, one or more shareholders may elect to have their allocated RECs sold by the SPGC 220 and receive the net proceeds from sale. The SPGC system 230 then determines the proceeds from the sales of the RECs less any withholdings, such as fees, sales commissions, or costs to obtain the proceeds. The cash distribution from the net sale proceeds of the sale of the RECs may be determined, using the following equation.

(RECs per SPGC Share*Net Sale Proceeds per REC)=REC Proceeds per SPGC Share

In another example, the SPGC system 230 may determine the Net Proceeds from Sales of the RECs per SPGC Share using the following calculation.

$$\frac{\begin{matrix}( Allocated RECs for Cash Distribution * \\ Net Sale Proceeds per REC )\end{matrix}}{Number of SPGC Shares allocated for Cash Distribution} = REC Proceeds per SPGC Share$$

In this calculation, the number of SPGC shares that are allocated to shareholders electing cash distributions is determined. The total allocated RECs for Cash distribution is multiplied by the net sale proceeds per REC and divided by the determined number of SPGC shares allocated to shareholders requesting Cash Distribution.

In some embodiments, a company may achieve its renewable energy goals or achieve renewable energy mandates by simply investing in shares of an SPGC 220 on a public market and receiving the REC distributions provided to SPGC shareholders 240. In some embodiments, a company may achieve its renewable energy goals, receive the investment returns of a VPPA, and have an effective power price inflation hedge by simply investing in shares of an SPGC 220 on a public market and receiving the REC distributions from the SPGC 220 as a shareholder. A shareholder may choose to transfer, or buy/sell, or retire, or hold, or import, or export their distributed RECs. A shareholder may retire certificates, for example, to comply with state mandates, or to fulfill their voluntary commitments, or ensure that certificates are not double counted, or any combination thereof.

Though RECs are described herein, RECs are one example and other credits instead of, or in addition to, RECs may be generated or employed where RECs are described herein. For example, the SPGC 220 may also receive and/or distribute production tax credits, or Investment Tax Credits (“ITC”), or other types of certificate or tax credits.

In some embodiments, at the end of the VPPA or the last settlement period in the VPPA, an SPGC 220 may return remaining capital and expire. In some embodiments, an SPGC 220 may hold at least a portion of excess capital and/or at least a portion of income, and/or may employ excess capital, or income, or capital, or unallocated capital, or free capital, or any combination thereof as capital or collateral to sign one or more new VPPAs.

In some embodiments, an SPGC 220 may be managed by a management company. In some embodiments, the management company may manage one or more SPGCs 220. In some embodiments, some members of the management team of the SPGC 220 may have experience and/or expertise in power markets, or energy projects, or VPPAs and/or may be involved in, for example, including, but not limited to, the identification, or due diligence, or contract negotiation of projects and/or VPPAs for the SPGC 220. In some embodiments, some members of the management team of the SPGC 220 may be involved in the development of energy projects. The SPGC management team, which may comprise a management company, may charge the SPGC 220 a management fee, salary, bonuses, or other compensation and fees, or any combination thereof.

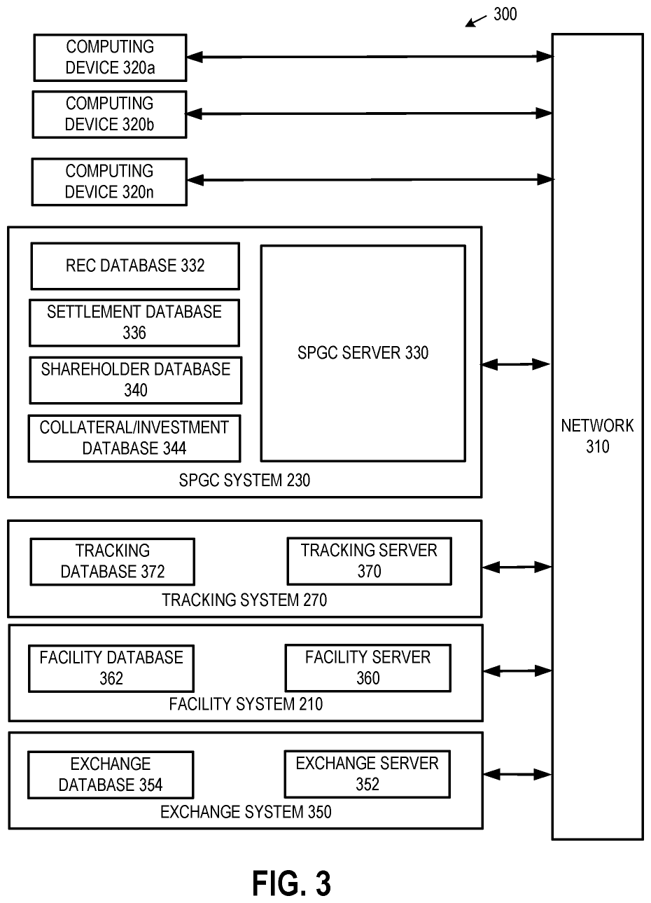

FIG. 3 depicts a schematic block diagram of an exemplary network environment 300 in accordance with one or more embodiments herein. The network environment 300 depicts an exemplary computing system that performs various functions and methods described herein. The depicted network environment 300 is only one example of a suitable computing environment and is not intended to suggest any limitation as to the scope of use or functionality. Numerous other general purpose or special purpose computing system environments or configurations may be used. Examples of special purpose computing systems, environments, and/or configurations that may be suitable for use include, but are not limited to, personal computers (“PCs”), server computers, handheld or laptop devices, multi-processor systems, microprocessor-based systems, network PCs, minicomputers, mainframe computers, cell phones, tablets, embedded systems, distributed computing environments that include any of the above systems or devices, and the like.

Computer-executable instructions such as program modules executed by a computer may be used with the shown special purpose computing systems. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

In the depicted embodiment, exemplary computing system 300 includes, inter alia, one or more computing devices and one or more servers. The computing devices 320a-n may include shareholder devices 250a-n, facility system user devices, SPGC System user devices, Tracking System user devices, etc. The SPGC system 230 may include one or more user devices, servers, or databases. For example, the SPGC server 330 and REC database 332 may track the received RECs and/or owing RECs under one or more VPPAs, and net proceeds from selling RECs. The SPGC server 330 and REC database 332 may compute the RECs distributed per SPGC share and/or the net proceeds from REC sales distributed per SPGC share. The SPGC server 330 and settlement database 336 may track settlement payments to/from the SPGC under one or more VPPAs. The SPGC server 330 may verify such settlement payments, e.g., using the Marketplace Price, Guaranteed Price and/or number of RECs under one or more VPPAs. The SPGC server 330 and settlement database 336 may also determine the settlement income per SPGC share and store settlement income distributions to the shareholders.

The SPGC server 330 and shareholder database 340 are used to identify, track, and manage shareholder information or data, such as names, addresses, emails, number of shares, elections for distributions of RECs or cash equivalents, etc. When the SPGC shares are listed and sold using the exchange system, the SPGC server 330 may communicate with the exchange system 350 to obtain the shareholder data.

The SPGC server 330 and collateral/investment database 344 may be used to determine and track capital received through SPGC share offerings and any capital distributions, e.g., as settlement payments or as excess capital distributions to shareholders. The SPGC server 330 and collateral/investment database 344 may be used to track investment income and investment distributions to shareholders.

The tracking system 270, e.g., of a public utility or other company operating the electrical grid 260, includes a tracking server 370 and tracking database 372. The tracking server 370 receives from the grid meter 272 a measure of a unit of power, such as 1 MWh of electricity, from the renewable energy facility 110. The tracking server 370 generates a REC for the 1 MWh and stores the REC in the tracking database 372 with the plurality of data attributes of the REC. The tracking server 370 may provide a web enabled interface to access the tracking database 372 and/or provide a search function to view issued RECs, REC owners, and other data attributes. The interface may also allow the owner of the REC to modify the data attributes to a new owner upon transfer of the REC, e.g., to the SPGC 220.

The facility system 210 includes a facility server 360 and facility database 362. The facility server 360 may receive an indication from the facility meter 212 when a unit of power, such as 1 MWh of electricity, is generated and delivered to the electrical grid 260. The facility server 360 may track the units of power delivered and verify the number of the RECs issued to the renewable energy facility 110 by the tracking system 270 of the electrical grid 260. An exchange system 350 includes an exchange server 352 and exchange database 354 for providing a platform for trading SPGC shares or other units of interest of the SPGC as described in more detail herein.

The databases are in general stored on a memory device, such as a server, and may be included in one or more of their respective servers. The devices, servers and databases shown in FIG. 3 are merely exemplary and one or more of the devices, servers and/or databases may be omitted or added or combined without departing from the scope of the present invention. Further, one or more databases may be included in one or more of the servers without departing from the scope hereof.

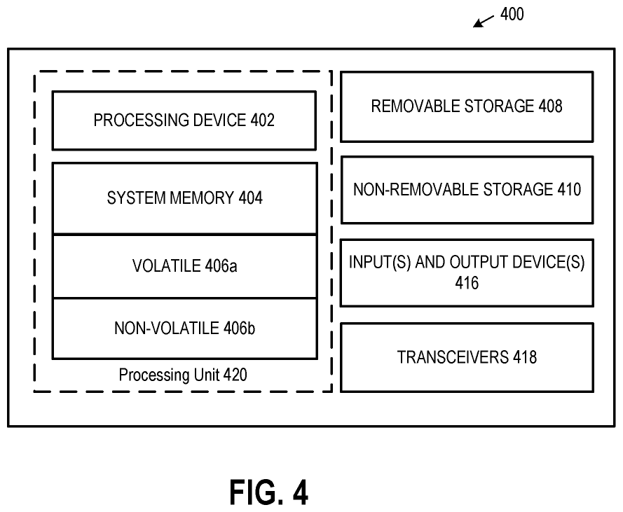

FIG. 4 depicts a schematic block diagram of an exemplary device, server and/or memory device in accordance with one or more embodiments herein. In its most basic configuration, as depicted in FIG. 4, a computing device, server, and/or memory device storing one or more of the databases includes at least one processing device 402 and at least one memory 404. Depending on the exact configuration and type of the computing device, memory 404 may be volatile (such as, random access memory (“RAM”)) 406a, non-volatile (such as read-only memory (“ROM”), flash memory, etc.) 406b, or some combination of the two. This most basic configuration of a processing unit 420 is included in each of the servers, computing devices, or servers.

Computing device 400 may have additional features/functionality. For example, computing device 400 may include additional storage, such as removable storage 408 or non-removable storage 410, including, but not limited to, magnetic or optical disks or tape, thumb drives, and external hard drives, RAM, ROM, electrically erasable programmable read-only memory (“EEPROM”), flash memory or other memory technology, CD-ROM, digital versatile disks (“DVD”) or other optical storage, magnetic cassettes, magnetic tape, magnetic disk storage or other magnetic storage devices, or any other medium or any other available storage media that can be accessed by computing device 400. The system memory 404 and/or the removable storage 408 and/or non-removable storage 410 includes computer-readable instructions, data structures, program modules, application-program interfaces (“APIs”), etc. that when executed by the processing device 402, causes the computing device 400 to perform one or more functions described herein. Such programs may be implemented in a high-level procedural or object-oriented programming language to communicate with a computer system. However, the program(s) can be implemented in assembly or machine language, if desired. In any case, the language may be a compiled or interpreted language, and combined with hardware implementations.

The computing device 400 further includes at least one input device, and at least one output device 416, such as a display or touch screen, touch pad, keyboard, printer, speaker, mouse, etc. The computing device 400 may also include one or more transceivers 418, such as a wireless or wired transceiver, that allows the device 400 to communicate with other devices over one or more networks. Such one or more transceivers include computer-readable instructions, data structures, program modules and/or other data, to transmit a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (“RF”), infrared and other wireless media.

In addition to that described herein, computing devices 400 can be any web-enabled handheld device (e.g., cell phone, smart phone, or the like) or personal computer including those operating via Android™, Apple®, and/or Windows® mobile or non-mobile operating systems.

Notably, referring back to FIG. 3, computing device 400 is one of a plurality of computing devices 320a-n and/or servers and/or databases inter-connected by network 310. As may be appreciated, network 310 may be one or more wide area networks (WAN), local area networks (LANs) or combinations thereof and the various devices may be connected thereto in any appropriate manner and communicate with one or more of the other devices in the computing system 300 using one or more protocols over the one or more networks 310. For example, network 310 may include one or more of a wired network, wireless network, or a combination thereof within an organization or home or the like and may include a direct or indirect coupling to an external network such as the Internet or the like. Likewise, network 310 may be such an external network including, without limitation, the Internet. In the exemplary embodiments shown herein, network 310 includes the Internet and allows the multiple systems necessary to implement the systems and methods discussed herein to communicate data quickly and efficiently. However, alternate networks and/or methods of communicating information may be substituted without departing from the scope hereof.

Although FIG. 3 depicts the various systems and devices and databases as located in close proximity, this depiction is not intended to define any geographic boundaries. For example, when network 310 includes the Internet, the devices can have any physical location. For example, computing device may be a tablet, cell phone, personal computer, or the like located at any user's office, home, etc. Or computing device could be located proximate to one or more servers without departing from the scope hereof. Also, although FIG. 3 depicts computing devices coupled to the servers via network 310, computing devices may be coupled directly to one or more servers via any other compatible networks including, without limitation, an intranet, local area network, or the like.

The depicted embodiment of network environment 300 may use a standard client server technology architecture, which allows users of one or more of the systems to access information stored in the databases via a custom user interface. In some embodiments of the present invention, the processes are hosted on one or more servers which are accessible via the Internet using a publicly addressable Uniform Resource Locator (“URL”). For example, users can access one or more of the systems using any web-enabled device equipped with a web browser. Communication between software component and sub-systems are achieved by a combination of direct function calls, publish, and subscribe mechanisms, stored procedures, and direct SQL queries, however, alternate components, methods, and/or sub-systems may be substituted without departing from the scope hereof. Also, alternate embodiments are envisioned in which a user device directly accesses one or more servers through a private network rather than via the Internet and a URL.

The devices in the computing environment 300 may be equipped with one or more Web browsers to allow them to interact with one or more servers and/or databases via a Hypertext Transfer Protocol (“HTTP”). HTTP functions as a request-response protocol in client-server computing. For example, a web browser operating on computing device 320a-n may execute a client application that allows it to interact with applications executed by the SPGC system 230. The client application submits HTTP request messages to the one or more servers in the SPGC system 200. The corresponding servers, which provide resources such as HTML files and other data or content or performs other functions on behalf of the client application, returns a response message to the client application upon request. The response typically contains completion status information about the request as well as the requested content. However, alternate methods of computing device/server communications may be substituted without departing from the scope hereof including those that do not utilize the Internet for communications.

In the exemplary computing environment 300, the databases may include a plurality of databases and/or database tables. As may be appreciated, the databases may be any appropriate database capable of storing data and may be included within or connected to one or more servers like those described herein in any appropriate manner without departing from the scope hereof.

The various techniques described herein may be implemented in connection with hardware or software or, as appropriate, with a combination of both. Thus, the methods and apparatus of the presently disclosed subject matter, or certain aspects or portions thereof, may take the form of program code (i.e., instructions, scripts, and the like) embodied in tangible media, such as floppy diskettes, CD-ROMs, hard drives, flash drives, DVDs or any other machine-readable storage medium wherein, when the program code is loaded into and executed by a machine, such as a computer, the machine becomes an apparatus for practicing the presently disclosed subject matter.

In the case of program code execution on programmable computers, the interface unit generally includes a processor, a storage medium readable by the processor (including volatile and non-volatile memory and/or storage elements), at least one input device, and at least one output device. One or more programs may implement or utilize the processes described in connection with the presently disclosed subject matter (e.g., through the use of an application-program interface (“API”), reusable controls, or the like). Such programs may be implemented in a high-level procedural or object-oriented programming language to communicate with a computer system. However, the program(s) can be implemented in assembly or machine language, if desired. In any case, the language may be a compiled or interpreted language, and combined with hardware implementations.

Although exemplary embodiments may refer to utilizing aspects of the presently disclosed subject matter in the context of one or more stand-alone computer systems, the subject matter is not so limited, but rather may be implemented in connection with other architectures, computing environments, or a distributed computing environment. Still further, aspects of the presently disclosed subject matter may be implemented in or across a plurality of processing chips or devices, and storage may similarly be affected across a plurality of devices in the computing environment 300. Such devices might include personal computers, network servers, and handheld devices (e.g., cell phones, tablets, smartphones, etc.), for example. In the exemplary embodiment, one or more servers and its associated databases are programmed to execute a plurality of processes including those discussed in greater detail herein.

SPGC Formation and Capital Requirements

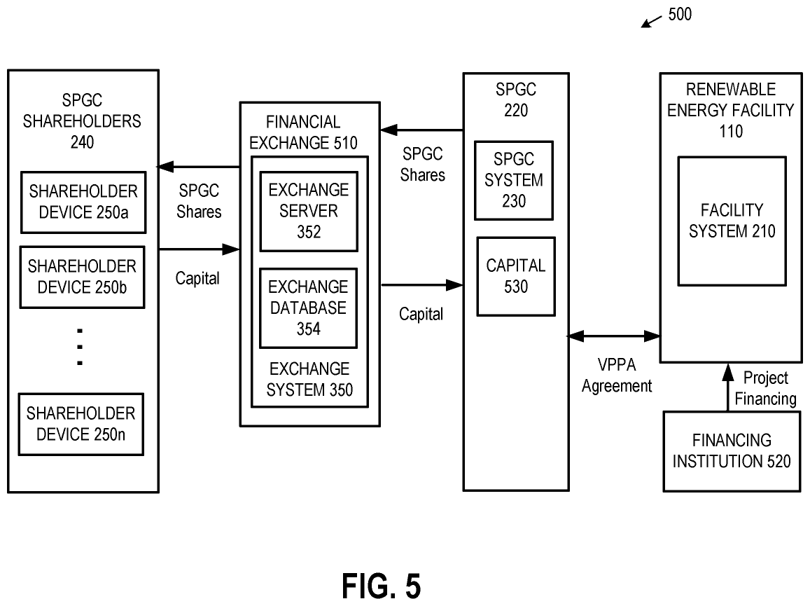

FIG. 5 depicts a schematic block diagram illustrating a formation process of an SPGC 220 in accordance with one or more embodiments herein. In some embodiments, the SPGC formation may comprise creating an investment company and raising capital required to meet the future potential VPPA obligations as a Guarantor for a currently operating project, or selected projects, or a target project, or a target project profile, or a to-be-determined project, or any combination thereof. The SPGC 220 may be created for a specific renewable energy project or may be created with the purpose of finding a suitable or target renewable energy project or VPPA, or any combination thereof. The SPGC 220 may already be in existence before the project developer began developing the project or may be created simultaneous to or after the project developer began developing the project, or any combination thereof. In general though, the SPGC 220 has a majority source of revenue from settlement payments and RECs received as a Guarantor of a Market Price for units of power generated by a renewable energy project, and a majority of capital is used as collateral for potential VPPA obligations.

In some embodiments, the shares, or ownership interests, or any combination thereof of the SPGC 220 may be transferrable, or tradable, or exchangeable, or any combination thereof. In some embodiments, the shares, or ownership interests, or any combination thereof of an SPGC 220 may be traded on a public stock exchange, or other public secondary market. The shares, or ownership interests, or any combination thereof of an SPGC 220 may be transferrable, or tradable, or exchangeable, or any combination thereof, and/or the shares, or ownership interests, or any combination thereof of an SPGC 220 may be traded on a public stock exchange, or other public secondary market.

Raising capital for an SPGC 220 may include, but not limited to, one or more or any combination of the following: selling shares of the SPGC 220 on a public market, a public listing of SPGC shares, an IPO, a pre-IPO, selling shares of the SPGC 220 to investors or selling shares of the SPGC 220 on a private market. For example, an SPGC 220 may raise $150,000,000 capital by selling at $15 per SPGC share for a total of 10,000,000 shares outstanding. As shown in FIG. 5, the shares may be sold on a private market or a public market, such as a financial exchange 510, which may include the New York Stock Exchange (NYSE), the Nasdaq, the London Stock Exchange (LSE), the Tokyo Stock Exchange (TSE), etc.

Before, concurrently, or after selling of the shares and receiving the capital, the SPGC 220 may then enter into a VPPA with a renewable energy project developer as a Guarantor. The SPGC 220 as a Guarantor agrees to guarantee the price of power produced by the renewable energy facility 110 or guarantee to ‘purchase’ the renewable energy to be produced by the renewable energy facility 110 at a Guaranteed Price per MWh, or any combination thereof over a predetermined time period. For example, the SPGC 220 may enter a VPPA contract-for-difference with the renewable energy facility 110 or system owner 120 to guarantee the price of future power produced by the project at $30 per MWh, or to ‘purchase’ the renewable energy power produced by the project at $30 per MWh, or any combination thereof over a term of 20 years. The renewable energy developer may utilize the commitment of the SPGC 220 to the VPPA, or the pre-signed VPPA with the SPGC 220, or the signed VPPA with the SPGC 220 to receive project financing, such as from banks or other financing institutions 520.

The SPGC 220 may need to hold collateral or capital 530 sufficient to cover potential future obligations in the VPPA as a Guarantor. In some embodiments, the required capital to be raised by a SPGC 220 may be determined by the theoretical or potential future cost of the VPPA obligations during each future settlement period, or by each future settlement date, or any combination thereof. For example, if the renewable energy facility 110 has a nameplate capacity of 100 MWh AC and a predicted capacity factor of 25%, the renewable energy facility 110 may be predicted to produce about 219,000 MWh of electricity per year and 4,380,000 MWh of electricity over a 20 year duration of the VPPA. If the VPPA has a price floor of $0 per MWh, a Guaranteed Price of $30 per MWh, and the project is predicted to produce 4,380,000 MWh of power over the 20 year duration, the SPGC 220 would need capital of about $131,400,000 to cover the worst case of the future power purchase obligations. This capital would cover the worst case scenario that the renewable energy facility 110 receives a Marketplace Price of $0 MWh for the 20 year period. The SPGC's capital requirements for a settlement period may thus be based on the Guarantor's potential future obligations over the term of the VPPA. In some embodiments, a project may have a range of predicted power productions over the course of the VPPA, in which case, a SPGC 220 seeking a higher credit rating or lower credit risk may raise or hold capital based on the different predicted ranges of power output predictions.

In some embodiments, when the project is pre-existing or already operating, an SPGC 220 may begin guaranteeing the price of power on the start date of the VPPA. In some embodiments, when the project is under development or not currently operating, an SPGC 220 may begin guaranteeing the price of power when the project begins producing power.

In some embodiments, an SPGC 220 may invest the capital or collateral. In some embodiments, an SPGC 220 waiting for a project to be developed may invest the capital or collateral. For example, in the present scenario, the renewable energy facility 110 may require 5 years before starting operations, and the SPGC 220 may invest the capital or collateral in 5-year treasury notes yielding 3 percent. The SPGC 220 may distribute the income from the invested capital to the SPGC shareholders 240. In some embodiments, the capital requirement of an SPGC 220 may be determined based on the future value of the current capital held by the SPGC 220, e.g., wherein the future value includes the value of expected investment income or investment returns.

In some embodiments, additional capital may need to be raised for the SPGC 220. For example, additional capital may need to be raised for a larger renewable energy project than anticipated, or a VPPA with greater power purchase obligations than anticipated, or any combination thereof. Additional capital may be raised by, for example, a secondary offering of SPGC shares or unit ownership interests.

In some embodiments, a SPGC 220 may achieve greater evaluated credit rating or lower evaluated credit risk by holding a greater amount of capital or by holding a higher percentage of potential future obligations in the VPPA, and/or by investing capital in low risk assets and/or by investing capital in high liquidity assets. For example, in some embodiments, if the predicted spread between the VPPA Guaranteed Price and the future market electricity price is substantial and/or may be hedged, the SPGC 220 may have capital holding requirements lower than the maximum potential future power purchase obligations. In some embodiments, the higher the capital holding of the SPGC 220 and/or the lower risk of the SPGC's investments, the greater the creditworthiness and lower the credit risk of the SPGC 220 as a power price Guarantor. In some embodiments, the structure of the VPPA, the wholesale power marketplace structure, wholesale power marketplace price dynamics, or any combination thereof may be included in the determination of SPGC capital holding requirements.

The credit rating or credit risk of an SPGC as a power price Guarantor is thus highly related to the capital holdings of the SPGC. The credit rating of the SPGC reflects whether the SPGC holds sufficient capital or collateral to cover the cost of potential future power purchase obligations in a VPPA as well as the risk and liquidity of the capital investments. As such, the credit rating of the SPGC 220 is independent of or unrelated to the credit rating or credit risk of any individual SPGC shareholder 240. Due to the capital holdings, the shareholders in the SPGC 220 are directly or indirectly isolated from responsibility or liability for the Guarantor obligations of the SPGC 220. Thus, unlike the currently known VPPA system, the SPGC shares are transferrable, tradable, exchangeable, or any combination thereof without effecting the credit rating of the SPGC 220.

This new system of SPGCs 220 as Guarantors helps renewable energy project developers and/or renewable energy project owners to secure a high credit rating Guarantor for a VPPA, while avoiding the hassle of finding and convincing large creditworthy corporations and institutions to be a Guarantor. For example, SPGCs 220 may be formed as needed, providing significant creditworthy competition to large corporations and institutions in the Guarantor market and/or potentially improving the terms, or duration of VPPAs, which may benefit renewable energy project developers and/or facilitate the deployment of renewable energy projects. Few corporations or institutions have perfect or near perfect credit ratings. However, SPGCs 220 with good capital holdings may be formed to provide a perfect or near perfect credit rating as needed, which may expand the available supply of Guarantors with perfect or near perfect credit rating. This greater number of SPGC Guarantors with perfect or near perfect credit rating may enable additional renewable energy project developers to secure a lower cost of financing, or a lower interest rate on debt, or better financing terms, or any combination thereof. The improved financing of power projects may reduce the required VPPA Guaranteed Price, the levelized cost of energy from a renewable energy project, or any combination thereof, which may facilitate increased building of renewable energy infrastructures and/or increase the affordability and/or reliability of electricity and/or increase the SPGC's income from electricity sales. Because SPGCs 220 may be formed as needed, SPGCs 220 may seize potential significant dislocations between the Guaranteed Price and average market price of electricity, which may exist due to a limited supply or constrained supply of large, creditworthy corporations or institutions with willingness to enter VPPAs as power price Guarantors.

In currently known systems in the prior art, only large companies with high credit ratings and capital holdings have the opportunity to enter into VPPAs and act as Guarantors. The SPGC 220 provides the opportunity and the benefits of a Guarantor to a wide range of investors. For example, the SPGC shareholders may include, but are not limited to, one or more or any combination of the following: individuals, low credit individuals, low income or high-income individuals, retail investors, small businesses, medium sized businesses, small institutions, medium sized institutions, low credit rated businesses, low credit rated institutions, non-profits, or any combination thereof.

Excess capital may comprise capital greater than the capital required to meet future potential power purchase obligations in a VPPA, or capital greater than the capital required to meet future potential power purchase obligations in a VPPA at each settlement period, or capital greater than the capital required to meet future potential power purchase obligations in a VPPA including anticipated investment income on capital, or capital greater than the capital required to meet future predicted power purchase obligations in a VPPA, or capital greater than the capital required to meet future predicted power purchase obligations in a VPPA including anticipated investment income on capital, or any combination thereof. Excess capital may comprise capital holdings greater than one or more or any combination of the following: the capital required by the SPGC 220 to meet its potential power purchase obligations, or future predicted power purchase obligations, or capital required by mandates, or capital required by guidelines, or capital required by operational parameters. In some embodiments, excess capital may occur or form or be realized at a settlement date because, for example, the average Market Price of power during the settlement period may be higher than the floor price, or the price of power which was employed in the determination of capital requirements, or any combination thereof. For example, when the average price of power during a settlement period or by the settlement date is greater than the minimum price of power or the price floor, than the SPGC 220 may have excess capital on the settlement date or after the settlement period because, for example, the SPGCs actual cost of power purchase obligations during the settlement period, if any, may be less than the allotted capital holdings to meet power purchase obligations during the settlement period.

In some embodiments, excess capital may be returned to shareholders, or excess capital may be reinvested, or any combination thereof. For example, if the SPGC 220 holds $150,000,000 of capital, but only desires or needs to hold $131,400,000 of capital, the SPGC may return at least a portion of the $18,600,000 of excess raised capital to the SPGC shareholders 240. In some embodiments, excess capital may be returned to SPGC shareholders 240 as a distribution. In some embodiments, excess capital may be returned to SPGC shareholders 240 as a SPGC share buyback.

In some embodiments, the SPGC may hold excess capital. For example, the SPGC 220 may hold excess capital to improve creditworthiness by increasing the capital to pay for potential power purchase obligations. In another example, the SPGC 220 may hold excess capital to enter into a new VPPA, or make strategic acquisitions, or make investments, or any combination thereof.

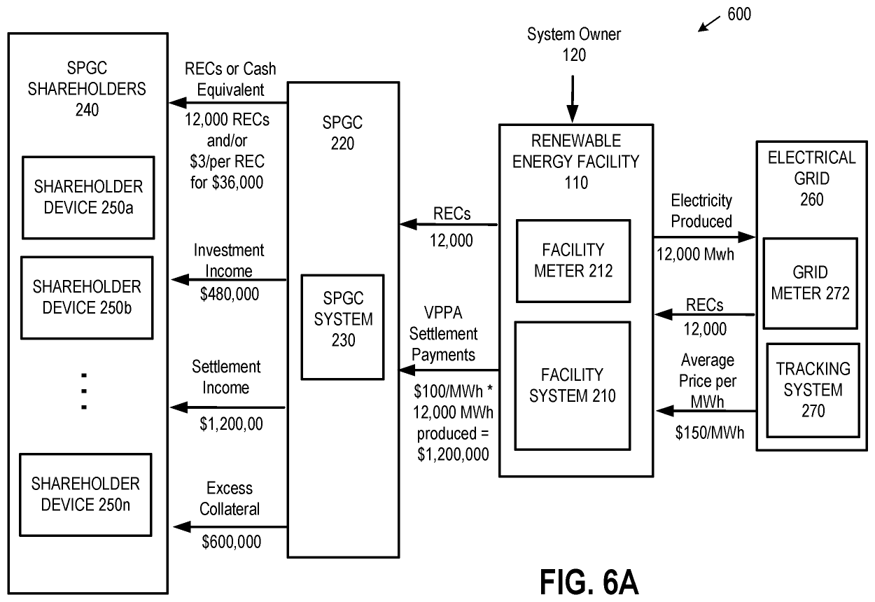

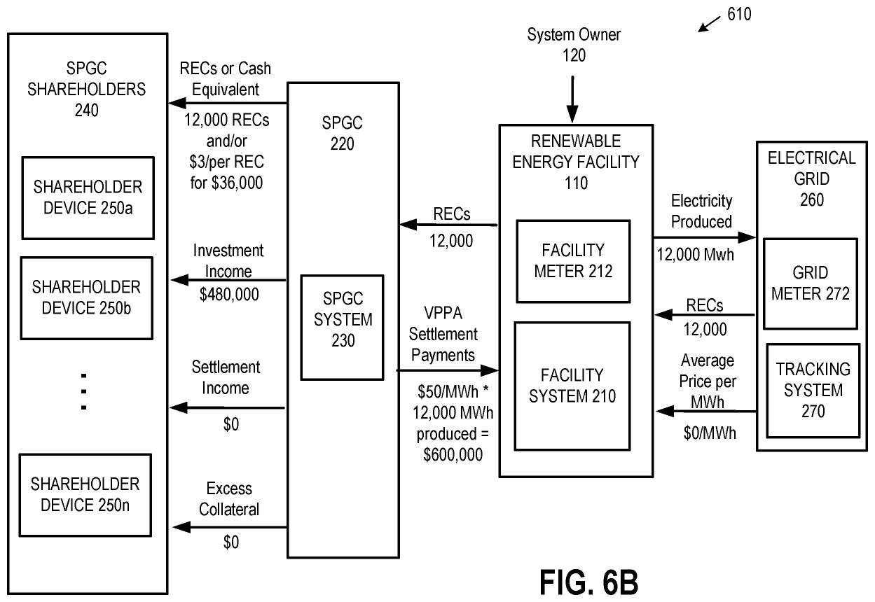

FIG. 6A depicts a schematic block diagram of an exemplary result 600 for an SPGC 220 at the end of a first settlement period in accordance with one or more embodiments herein. In this embodiment, an ideal scenario with a good return of investment to the SPGC 220 is shown. For this example, the Guaranteed Price in the applicable VPPA is $50/MWh of electricity produced by the renewable energy facility 110 with a Floor Price of $0/MWh. With a predicted production of 12,000 MWh by the renewable energy facility 110, in this example, the SPGC 220 has pre-allocated collateral in the amount of $600,000 to meet the potential VPPA obligations for this settlement period, e.g., $50/MWh*12,000 MWh=$600,000. Assuming a 20 year term for the VPPA and 240 settlement periods, the SPGC 220 has total capital of $144,000,000 for this example.

For this ideal scenario, the average Market Price during the settlement period is $150/MWh and 12,000 MWh are produced by the renewable energy facility 110. The renewable energy facility 110 thus receives $1,800,000 for the produced electricity and 12,000 RECs. Under the VPPA, the renewable energy facility 110 transfers the 12,000 RECs to the SPGC 220. In addition, the positive settlement payment of $1,200,000 is determined from the difference of the Market Price of $150 MWh less the Guaranteed Price of $50/MWh multiplied by the produced 12,000 MWh of electricity.

In some embodiments, the SPGC system 230 may distribute the RECs or cash equivalent (e.g., $3 per REC) to the SPGC shareholders. Assuming 1,000,000 outstanding shares, then 0.012 RECs per share are distributed or $0.036 per share is distributed (less any withholdings for fees).

In some embodiments, the SPGC system 230 may distribute the settlement income of $1,200,00 to the SPGC shareholders. Assuming 1,000,000 outstanding SPGC shares, then $1.20 per share of settlement income (less any withholdings for fees) is distributed.

In some embodiments, the SPGC system 230 may distribute excess capital no longer allocated as collateral for potential VPPA obligations for a settlement period. In this example, the SPGC 220 has pre-allocated collateral in the amount of $600,000 for this settlement period. Since this capital of $600,000 is no longer required as collateral, it is “excess collateral”. The SPGC 220 may thus determine “excess collateral” when Market Prices for power produced are greater than the Floor Price in the VPPA (or $0.00 per kWh when no Floor Price is in the VPPA) during a settlement period, or when the Market Price for power produced are greater than or equal to the Guaranteed Price during a settlement period, or a combination thereof. Then the collateral allocated for the settlement period, or the remaining collateral allocated for that settlement period may include excess collateral.

All or a portion of excess collateral may be distributed to the SPGC shareholders 240. Again, in this example scenario, assuming 1,000,000 outstanding SPGC shares, and $600,000 excess collateral for the settlement period, then $0.60/share of excess capital from the settlement period may be distributed. In some embodiments, the excess collateral may be distributed to shareholders continuously, or monthly, or quarterly, or semi-annually, or annually, or at the settlement date or at the end of each settlement period, or another timespan or frequency. In some embodiments, excess collateral may be distributed to shareholders on a different date than settlement income distributions. In some embodiments, excess collateral may be distributed to unit holders on the same date as income distributions.

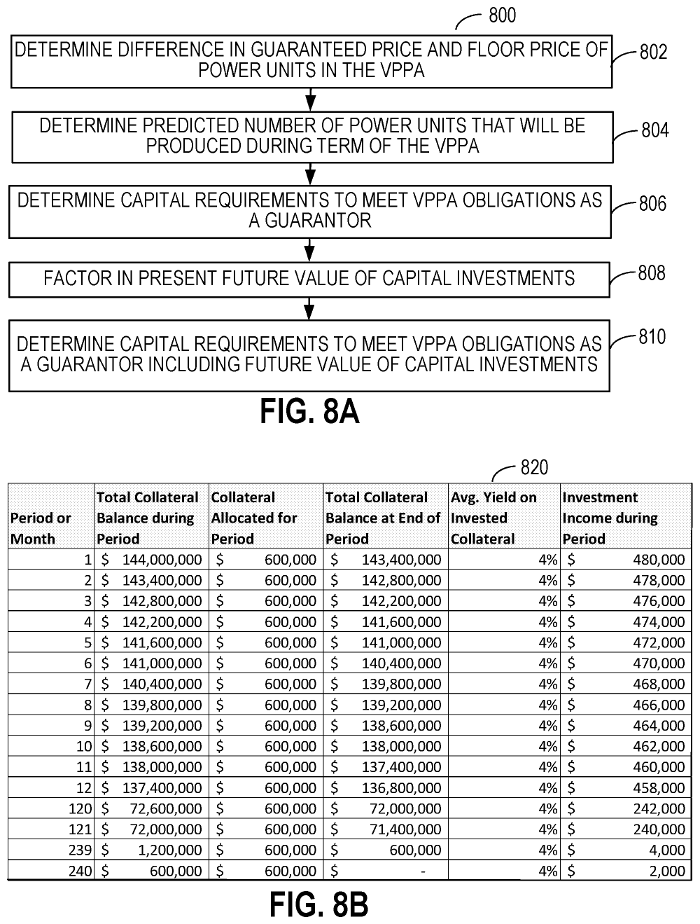

In some embodiments, the SPGC 220 may also distribute investment income earned during the distribution period. For example, as shown in more detail with respect to FIG. 8B, the capital raised by the SPGC 220 totals $144,000,000 ($600,000*240 settlement periods) with an assumed investment of the capital having an average yield of 4%. The investment income during the first one-month settlement period, is then $480,000. Again assuming 1,000,000 outstanding SPGC shares, then $0.48/share of capital investment from the settlement period is distributed. The SPGC system 230 may generate electronic notifications, such as emails or texts, to the plurality of shareholders. The notification to a shareholder may include information on the investment income distributions to that shareholder. The SPGC system 230 may also electronically communicate with a bank or banking service of the SPGC 220 to initiate the payments of the shareholder distributions.

In total, in the ideal scenario of FIG. 6A, a shareholder with 100 shares would receive, from this settlement period, $120 settlement income, $60 excess capital, $48 of capital investment, and 1.2 RECs or $0.36 cash distribution from RECs. The distribution period of the SPGC 220 may be quarterly, so these calculations may be performed for three settlement periods, e.g., by the SPGC system 230, and the summation of the three settlement periods be distributed for the quarter.

FIG. 6B depicts a schematic block diagram of a “worst case” exemplary result 610 for an SPGC 220 at the end of a first settlement period in accordance with one or more embodiments herein. For this example, the same terms of the VPPA are assumed as in FIG. 6A, e.g., the Guaranteed Price in the applicable VPPA is $50 per MWh of electricity produced by the renewable energy facility 110 with a Floor Price of $0 per MWh. The SPGC 220 has pre-allocated collateral in the amount of $144,000,000 to meet the potential VPPA obligations over its 240 settlement periods and specifically $600,000 collateral allocated for this first settlement period.

For this worst-case scenario, the average Market Price obtained during the settlement period is $0/MWh and the power produced by the renewable energy facility 110 is 12,000 MWh. The renewable energy facility 110 received no cash compensation but still received 12,000 RECs for the produced 12,000 MWh. Under the VPPA, the renewable energy facility 110 transfers the 12,000 RECs to the SPGC 220.

Since the Market Price $0/MWh is below the Guaranteed Price of $50/MWh, the settlement payment of $600,000 (e.g., 50/MWh*12,000 MWh) is paid by the SPGC 220 to the renewable energy facility 110. The settlement payment of $600,000 equals the total allocated collateral held by the SPGC 220 for this first settlement period.

In some embodiments, the SPGC system 230 may still distribute the RECs or cash equivalent (e.g., $3/REC) to the SPGC shareholders. Assuming 1,000,000 outstanding shares, then 0.012 RECs per share are distributed or $0.036 per share is distributed (less any withholdings for fees). In addition, the investment income during the first one month settlement period of $480,000 may also be distributed. Again assuming 1,000,000 outstanding SPGC shares, then $0.48/share of capital investment from the settlement period is distributed. However, no settlement income or excess capital is obtained or distributed by the SPGC 220 during this period.

A shareholder with 100 shares would receive, in this worst-case scenario, $48 of capital investment and 1.2 RECs or $0.36 cash distribution from RECs for the settlement period. Again, the distribution period of the SPGC 220 may be quarterly, so these calculations may be performed for three settlement periods, e.g., by the SPGC system 230, and the summation of the three settlement periods would be distributed for the quarter.

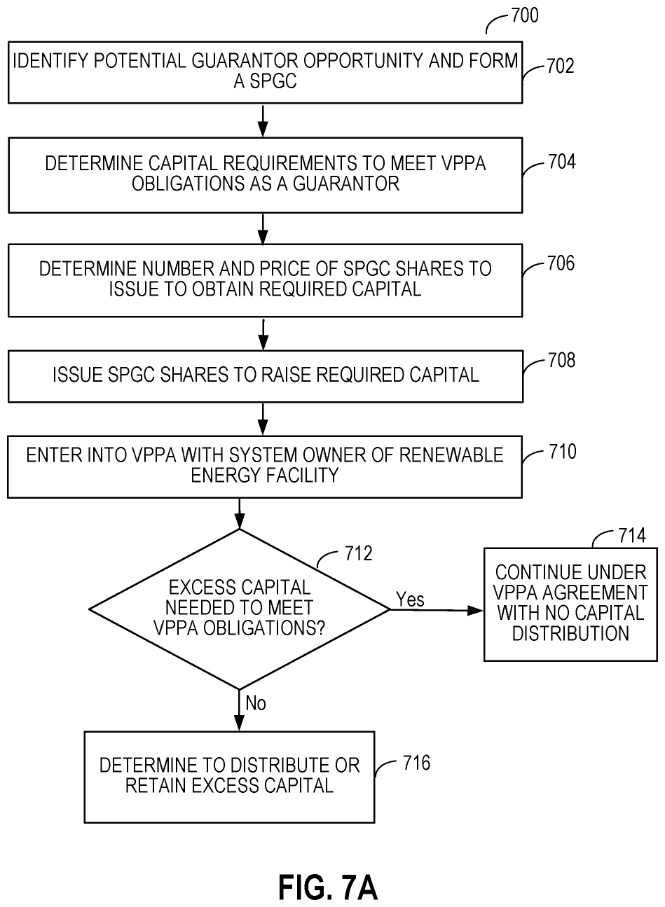

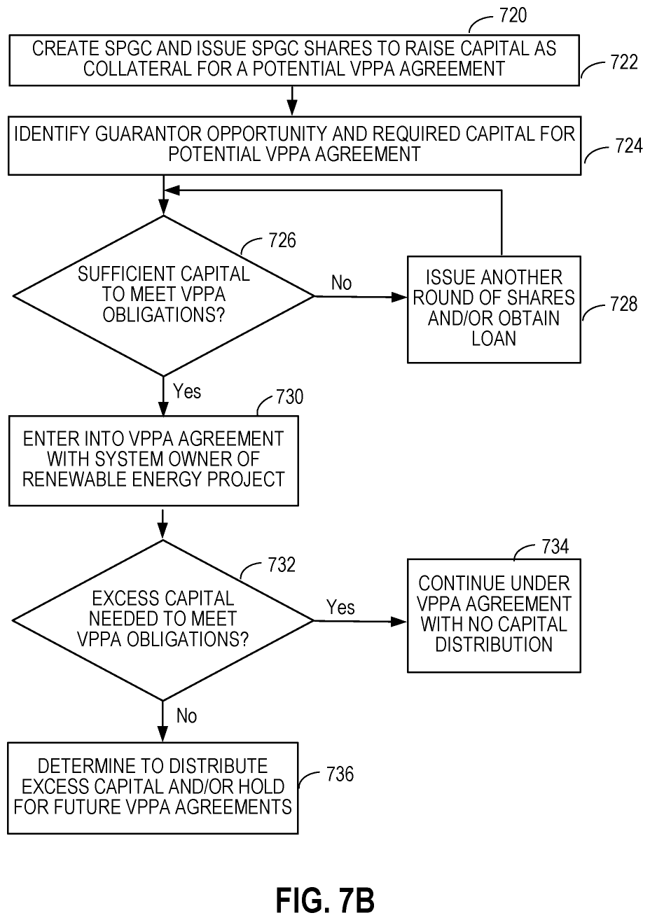

FIG. 7A depicts a flow chart of an exemplary method 700 for formation of an SPGC 220 in accordance with one or more embodiments herein. In this example, an investment or management group identifies a Guarantor opportunity, e.g., with a System Owner 120 planning or developing or building a new renewable energy facility 110 or expanding a current renewable energy facility 110 or has a currently operating renewable energy facility 110. The management group forms or creates a new SPGC 220 in response to the Guarantor opportunity at 702. The SPGC 220 formed is a company, corporation, or other legal entity, that issue shares (e.g., wherein “shares” means any types of equity units, including preferred or common stock, or securities), and wherein a majority of its capital functions or will function as collateral for current or future potential payment obligations as a Guarantor in a VPPA and/or a majority of its revenue is from acting as a Guarantor under a VPPA.

The capital requirements to meet the Guarantor obligations under a VPPA are then determined at 704. For example, the SPGC system 230 may calculate the required capital to meet worst case payment requirements as a Guarantor under the VPPA, as described in more detail with respect to FIGS. 8A and 8B. The number and average price of SPGC shares needed to obtain the required capital is determined at step 706. The SPGC shares may include any type of equity units in the SPGC 220, such as common or preferred stocks or securities. The SPGC shares are then issued and sold, e.g., through the financial exchange 510, to raise the required capital at step 708.

In some embodiments, upon the formation or creation of the SPGC 220 and the first issuance of shares, the value of the SPGC 220, or the book value of the SPGC 220, or the liquidation value of the SPGC 220 may be equal to the collateral held by the SPGC 220, which may comprise proceeds from the issuance of the shares. In some embodiments, upon the formation or creation of the SPGC 220 and the first issuance of shares, the book value of the shares may be equal to the total outstanding shares divided by the total collateral held by the SPGC 220. In some embodiments, upon the formation or creation of the SPGC 220 and the first issuance of shares, proceeds held by the SPGC 220 may comprise assets or equity or book value, although may be referred to as collateral.

With the capital from this first offering, the SPGC 220 may pursue the Guarantor opportunity and enter into a VPPA with a System Owner at 710. The duration of the VPPA, or the duration of a SPGC 220, or any combination thereof may be any time period including, but not limited to: 1 month, 3 months, 6 months, 1 year, 2 years, 3 years, 4 years, 5 years, 6 years, 7 years, 8 years, 9 years, 10 years, 12 years, 15 years, 18 years, 20 years, 25 years, 30 years, 35 years, or a combination thereof.

The SPGC 220 may determine whether the SPGC 220 has excess capital not needed as collateral to meet the Guarantor obligations under the VPPA at 712. If the excess capital is needed at step 712, the SPGC 220 continues to operate under the VPPA agreement without a capital distribution at step 714. If excess capital is not needed at step 712, the SPGC 220 may determine to distribute the excess capital to the shareholders. In some embodiments, the SPGC 220 may still retain the unneeded excess capital, e.g., for possible future VPPA agreements or investments at step 716. In some embodiments, the SPGC 220 may determine to retain a portion of the excess capital and to distribute a portion of the excess capital.

In some embodiments, an SPGC 220 may offer shares as packaged securities including rights to the net proceeds from the settlement income under a VPPA for a predefined time period (e.g., 1 year, 2 years, 5 years, 10 years, 20 years), which may enable the SPGC to secure a profit for SPGC shareholders for the duration or period of time of the packaged security.

FIG. 7B depicts a flow chart of another exemplary method 720 for formation of an SPGC 220 in accordance with one or more embodiments herein. In this embodiment, the SPGC 220 is formed and a number of shares in the SPGC 220 are issued at step 722. Then based on the capital raised, a Guarantor opportunity is identified at step 724, and the required capital to meet the Guarantor obligations under a potential VPPA is determined.

It is then determined at step 726 whether the SPGC 220 has sufficient capital to use as collateral to meet the Guarantor obligations under the potential VPPA. In some embodiments, the difference between the collateral required and the capital held by the investment company 610 may not be sufficient and additional capital is required. In some embodiments, at step 728, the investment company 610 may issue and/or sell more shares and/or may conduct a secondary offering, wherein the proceeds from said issuance and/or selling of investment company shares or conducting a secondary offering may comprise the additional needed collateral, or at least a portion of collateral, or at least a portion of additional collateral required. In some embodiments, the SPGC 220 may obtain a loan to provide, for example, a portion of the additional collateral required. In some embodiments, a loan may be employed to temporarily provide a portion of additional collateral required.

In some embodiments, at step 726, the difference between the collateral required for the VPPA and the capital held by the investment company 610 is sufficient and additional capital is not required. The SPGC 220 then enters into the VPPA as the Guarantor at 730.

In some embodiments, the investment company 610 may enter into the VPPA when the collateral required to pay future potential Guarantor obligations is greater than the capital held by the investment company 610. The SPGC 220 may enter into the VPPA and then raise the additional needed capital, e.g., it may issue and/or sell more shares and/or may conduct a secondary offering and/or obtain a loan. The SPGC 220 may thus be formed, and shares issued prior to, concurrently or after the SPGC 220 executes a VPPA agreement.

The SPGC 220 may at any point during the VPPA, decide whether it has excess capital not needed to meet VPPA obligations as a Guarantor at 732. If the excess capital is needed at step 732, the SPGC 220 continues to operate under the VPPA agreement without a capital distribution at step 734. If the capital is not needed at step 732, the SPGC 220 may determine to distribute the excess capital to the shareholders or retain the excess capital, e.g., for possible future VPPA agreements or investment at step 736. Again, the SPGC 220 may retain any excess capital or opt to distribute any excess capital to the shareholders at step 736.

FIG. 8A depicts a flow chart of an exemplary method 800 for determining the capital requirements of an SPGC 220 in accordance with one or more embodiments herein. Capital or collateral may be defined as money, or liquid assets, or assets, or cash, or cash equivalents, or any combination thereof available for payments by the SPGC 220 under the VPPA. To obtain and/or retain a high credit rating, the SPGC 220 may need to hold capital sufficient to cover the maximum theoretical payments as a Guarantor for the duration of the VPPA, for each future settlement period, or by each future settlement date, or any combination thereof.

The maximum theoretical cost to the Guarantor is determined when the Market Price is less than the Floor Price, as defined in the VPPA. In this worst case scenario, the Guarantor owes the Guaranteed Price less the Floor Price, i.e., the maximum price difference guaranteed in the VPPA. This maximum price difference between the Guaranteed Price and the Floor Price is determined at step 802.

In some embodiments, the total collateral required may be determined by predicting an estimated electricity production from the renewable project during the duration of the VPPA. For example, in some VPPAs, the Guarantor guarantees the purchase price of the total power production of the renewable energy facility during the predetermined term of the VPPA. In this example, the predicted or forecasted number of power units is determined from the total estimated power production of the renewable energy facility 110 at step 804. In some embodiments, a renewable energy facility may have a range of power productions over the course of the VPPA. For example, the renewable energy facility may not run at full capacity for a first year during development or may run at a higher capacity during winter or summer months. In this embodiment, the different predicted ranges of power output over the term of the VPPA, or an average thereof, may be used in the determination. In some embodiments, the capital required may be determined based on the maximum total feasible electricity produced by the renewable energy facility during the duration of the VPPA. In some embodiments, a contingency percentage or buffer may be added to the forecasted total number of power units or to the maximum total feasible electricity produced by the renewable energy facility during the duration of the VPPA.

The maximum theoretical cost to the Guarantor during the entire term of the VPPA may then be determined at step 806, using the calculation below.

(Guaranteed Price−Floor Price)*Predicted Number of Power Units during term of VPPA=Maximum theoretical cost to Guarantor under the VPPA

In some embodiments, the VPPA may include a cap or maximum production covered by the Guaranteed Price. For example, the VPPA may include a cap that only 10,000 MWh per month is covered by the Guaranteed Price and/or a cap that a maximum of 2,400,000 MWh of power is covered during the term of the VPPA. In this case, the predicted number of power units may then be determined based on the cap or maximum number of power units specified in the VPPA.

In some embodiments, when the SPGC 220 invests capital, then a predicted future value of the investments may be factored into the determination of the collateral needed to cover the maximum theoretical cost of the VPPA obligations at step 808. For example, FIG. 8B depicts a graph of an example of potential investment income from collateral held by the SPGC 220. In this example, an average yield on invested collateral of 4% is used to determine the investment income for each one-month settlement period over a 20-year period. This predicted investment income may be used to meet the collateral requirements in future settlement periods. For example, a VPPA may have an estimated power purchase obligations of $1,444,000,000 over the 20-year term of the VPPA, as shown in FIG. 8B. The SPGC 220 may determine an estimated investment income during the 20 period at 4% or other low risk rate. This estimated investment income may be added to the initial capital to meet collateral requirements for future settlement periods at step 810. The SPGC 220 may determine an initial capital an average yield such that the expected future value of the initial capital is greater than or equal to the predicted VPPA payment obligations. Thus, the required initial capital may be equal to the predicted VPPA payment obligations, less any anticipated investment income.

The SPGC 220 may invest in, for example, low risk fixed income securities, such as federal government bonds, which may involve a fixed income investment ladder with fixed income durations matching or nearly matching the dates of settlement periods. The capital requirements to meet the VPPA obligations may be determined in step 810 of FIG. 8A, factoring in the present future value of the capital investments.

The required capital may thus vary depending on the SPGC 220 desired credit rating, desired investment income, or other factors. In some embodiments, the required capital is greater than the future predicted VPPA payment obligations. In some embodiments, the required capital is less than the future predicted VPPA payment obligations. In some embodiments, the required capital is equal to, for example, 80%, 100%, or 130% of the future predicted VPPA payment obligations. In some embodiments, the required capital is equal to the future predicted VPPA payment obligations, in addition to the anticipated investment returns from invested capital.

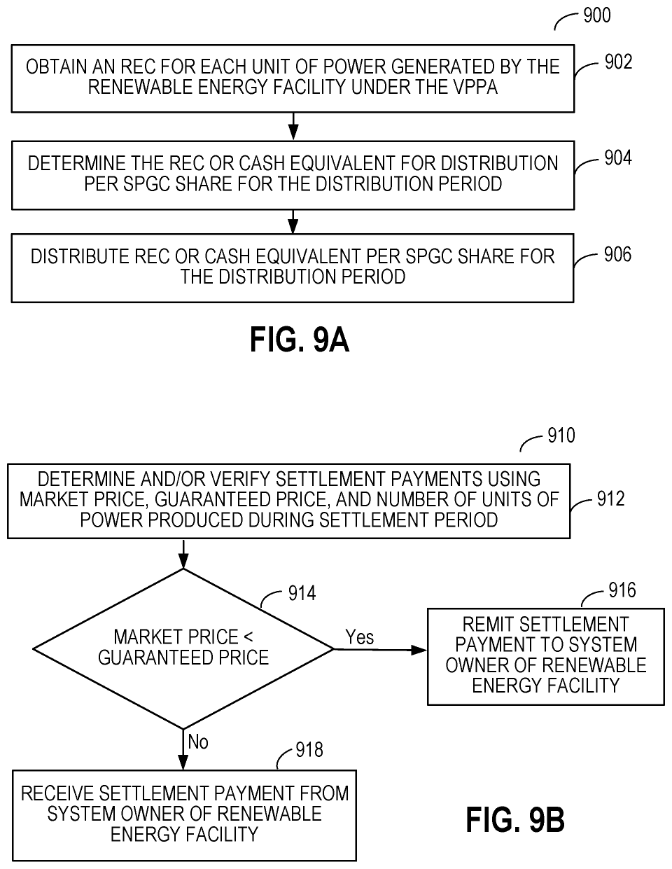

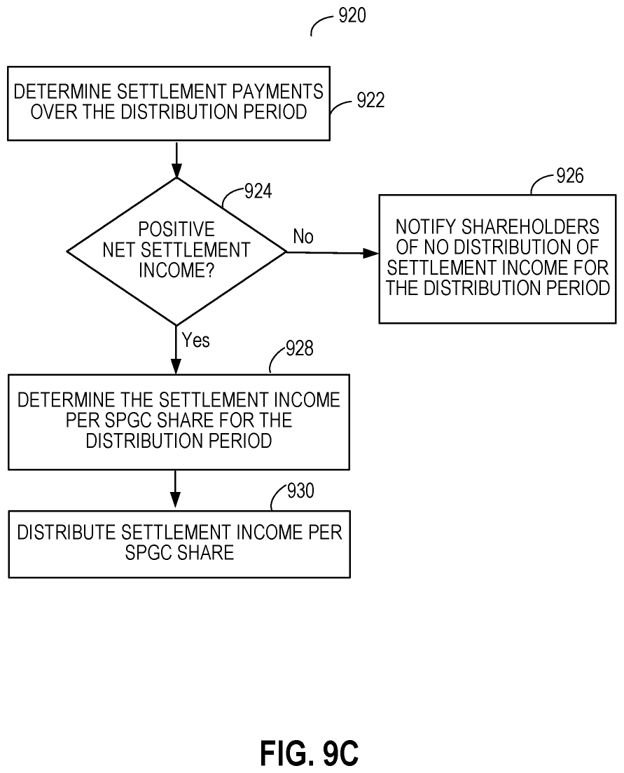

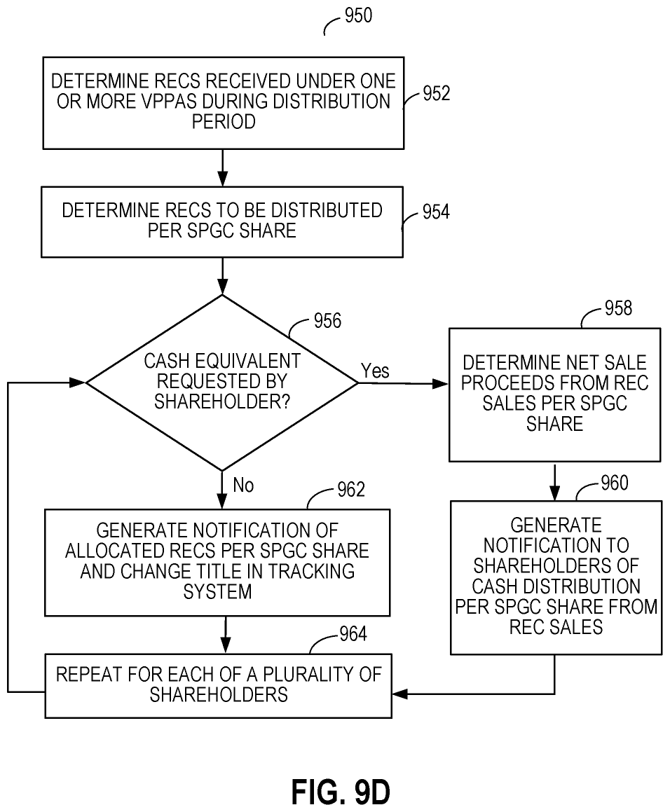

FIG. 9A depicts a flow chart of an exemplary method 900 for shareholder distributions of RECs by a SPGC 220 in accordance with one or more embodiments herein. When the renewable energy facility 110 in the VPPA is in operation, units of power that are produced and delivered to the electrical gid 260 are tracked, e.g., using a facility meter 212 and/or grid meter 272. For each unit of power, the renewable energy facility 110 is issued a REC documenting the unit of power, e.g., by the tracking system 270 of the electrical grid 260. Generally, in accordance with the VPPA, the renewable energy facility 110 transfers the ownership of the REC to the SPGC 220 at 902. For example, the title to the REC may be transferred to the SPGC 220 in the tracking system 270 by the renewable energy facility 110, and the owner of record updated in the tracking system 270. The SPGC system 230 may access the tracking system 270 and verify the number of and the transfer of title to the RECs allocated to the SPGC by the renewable energy facility 110.

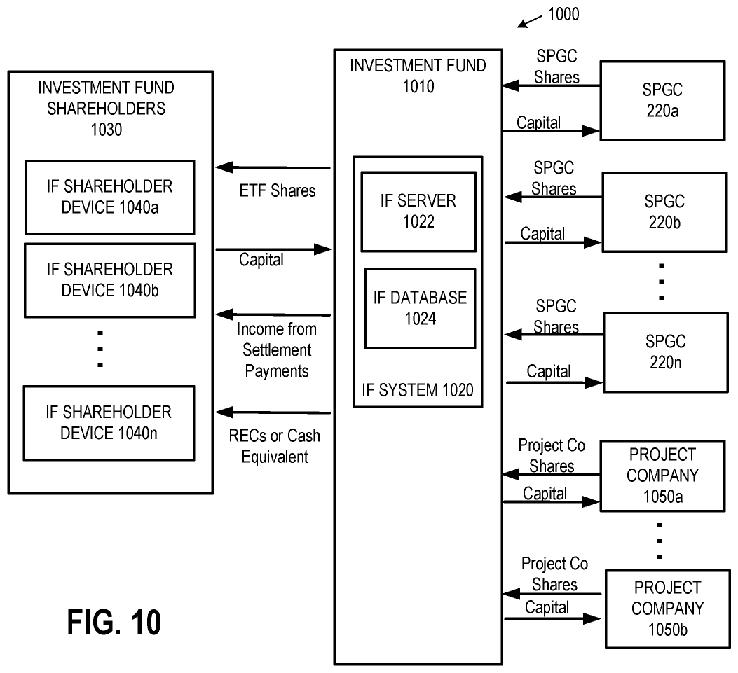

For a distribution period, the RECs (or fractions of RECs) or the cash equivalent thereof, per SPGC share is determined at step 904, as described further with respect to FIG. 10. The RECs (or fractions of RECs) or the cash equivalent thereof, per SPGC share for the distribution period are then distributed to the SPGC shareholders at step 906.

FIG. 9B depicts a flow chart of an exemplary method 910 for determination of settlement income by an SPGC System 230 in accordance with one or more embodiments herein. The SPGC system 230 determines and/or verifies settlement payments for a settlement period at 912. The SPGC system 230 obtains the number of units of power produced by the renewable energy facility 110 during the settlement period (e.g., number of MWh of electricity produced with a Guaranteed Price under the VPPA), the Market Price obtained for any sold units of power, and the Guaranteed Price in the VPPA. The SPGC system 230 determines a difference between the Guaranteed Price and either the Market Price or the Floor Price, whichever is higher. This difference in price is multiplied by the number of units of power produced during the settlement period to obtain the settlement payment.

When the Market Price is less than the Guaranteed Price at 914, the SPGC 220 remits the settlement payment to the renewable energy facility (e.g., to the System Owner) at 916. When the Market Price is greater than the Guaranteed Price at 914, the renewable energy facility 110 (e.g., the System Owner) transmits the settlement payment to the SPGC 220 at 918.

FIG. 9C depicts a flow chart of an exemplary method 920 for determination of a distribution of settlement income by the SPGC system 230 in accordance with one or more embodiments herein. When the settlement period in the VPPA is different than the distribution period of the SPGC 220, the settlement payments under the applicable VPPA over the distribution period are determined at 922. For example, the settlement period in a VPPA may be 1 month and the distribution period set by the SPGC 220 may be quarterly. So, three settlement payments for each of the three monthly settlement periods occur during the quarterly distribution period. At 924, it is determined (e.g., by the SPGC system 230) whether the settlement payments during the distribution period resulted in a positive net settlement income. For example, during the distribution period, when the settlement payments to the SPGC 220 are less than the settlement payments paid by SPGC 220, then the net settlement income is negative at 924. The SPGC system 230 may then generate notifications to shareholders that no distribution of settlement income will be distributed for the current distribution period.

When the settlement payments to SPGC 220 are greater than the settlement payments paid by SPGC 220, then the net settlement income is positive at 924. The settlement income per SPGC share for the distribution period is then determined at 928 and distributed to the shareholders at 930. The SPGC system 230 may generate electronic notifications, such as emails or texts, to the plurality of shareholders 240 or shareholder devices 250a-n. The SPGC system 230 may also electronically communicate with a bank or banking service of the SPGC 220 to initiate the payments of the shareholder distributions.

In some embodiments, SPGC 220 may retain all or a portion of investment and/or settlement income rather than distribute the income to the shareholders. For example, in some embodiments, the SPGC 220 may hold all or a portion of such income to increase capital and/or improve creditworthiness. For example, in some embodiments, the SPGC 220 may hold income to enable sufficient capital to enter a new VPPA, or to make strategic acquisitions, or to buyback SPGC shares, or any combination thereof.

FIG. 9D depicts a flow chart of an exemplary method 950 for determination of distribution of RECs, or cash equivalent thereof, for shareholders of a SPGC 220 in accordance with one or more embodiments herein. In some embodiments, for a distribution period, the number of RECs received under the applicable VPPA is determined at step 952. Based on the outstanding SPGC shares, the number of RECs allocated per SPGC share is determined at step 954. In an embodiment, one or more shareholders may elect to receive the allocated RECs per share while one or more other shareholders may elect to have their allocated RECs sold by the SPGC 220 and receive the net proceeds from the sale. The SPGC system 230 may be used to determine the election for each shareholder at step 956. When a shareholder elects the cash equivalent for their allocated RECs, the SPGC system 230 at step 958 determines the cash distribution to the shareholder, e.g., using the following calculation.

(RECs Allocated per SPGC Share*Net Sale Proceeds per REC)*Number of Shares of the Shareholder=Cash Distribution to Shareholder from sale of RECs

A notification to the shareholder may be generated at step 960, e.g., by the SPGC system 230, including information on the cash distribution from sale of their allocated RECs. The payment may also be scheduled using the SPGC system 230. The notification may be digital, such as an automated email, text, etc.

When a shareholder elects to receive their allocated RECs per share at step 956, a notification may be generated at step 962, e.g., by the SPGC system 230, to the shareholder including information on the allocated RECs. The title of the allocated RECs may be transferred to the shareholder in the applicable tracking system using the SPGC system 230. This process is repeated for each of the plurality of shareholders, as shown at step 964.

### Embodiment of an Investment Fund System

FIG. 10 illustrates a schematic block diagram of an exemplary system 1000 for an investment fund (“IF”) in accordance with one or more embodiments herein. The investment fund 1010 includes a corporation, company, or other legal entity that issues shares, wherein the term shares include any type of equity unit or securities. In this embodiment, the investment fund 1010 includes one or more of: an exchange traded fund (“ETF”), a mutual fund, a closed end fund, or other investment fund. In some embodiments, the investment fund 1010 may invest in one or more SPGCs 220a-n or hold shares of one or more SPGCs 220a-n. In some embodiments, the majority of the underlying assets and/or revenue of the investment fund 1010 are the investments in the SPGCs 220a-n, e.g., such as shares of the SPGCs 220a-n. For example, the investment fund 1010 may be created to purchase and hold shares in a plurality of SPGCs 220a-n. Investors or other potential market participants may be interested in owning shares of, or having exposure to, or any combination thereof, more than one SPGC 220a-n to, for example, including, but not limited to, one or more or any combination of the following: reduce risk, or improve risk weighted returns, or diversify income, or diversify REC sources, or access greater market depth, or access greater market liquidity, or access equity options, or access market trends, or manage re-investment of SPGC capital distributions, or manage sale of RECs, or manage REC distributions, or achieve an investment strategy, or achieve an investment objective. The investment fund 1010 may thus provide shareholders the ability to diversify and/or mitigate or eliminate risk from sole sourcing. In some embodiments, the investment fund 1010 does not directly participate or agree to act as the Guarantor under a VPPA or otherwise directly guarantee a purchase price of renewable energy, but rather is only a shareholder to the plurality of SPGCs 240a-n that are acting as Guarantors.

In some embodiments, a company that owns a current or to be developed renewable energy facility may distribute RECs to shareholders (a “Project Company”). The Project Company 1050 may include a company, corporation, or other legal entity that issues equity units to a plurality of shareholders and directly owns a current or in development or to be developed or in planning renewable energy facility 110 that generates or will qualify to generate RECs. The investment fund 1010 may hold shares of said Project Company 1050. The investment fund 1010 may distribute the RECs received from the shares of the Project Company 1050 to the shareholders 1040a-n of the investment fund 1010. When the investment fund 1010 holds shares in a plurality of Project Companies 1050 and/or SPGCs 220, the investment fund 1010 may provide a diversified source of RECs and/or settlement income to investors.

An investment fund 1010 that owns shares of a plurality of SPGCs 220a-n and/or Project Companies 1050a-n may pass through all or a portion of the cashflows and/or the RECs distributed to shareholders of the plurality of SPGCs 220a-n and/or Project Companies 1050a-n to the IF shareholders 1030. The investment fund 1010 may thus provide a diversified source of cashflows and/or renewable energy credits to the IF shareholders 1030. In some embodiments, the investment fund 1010 holding shares of SPGCs 220a-n and/or Project Companies 1050a-n may sell RECs and/or other created certificates provided by the underlying shares and distribute the net proceeds from the sale of RECs to the IF shareholders 1030. In some embodiments, the IF shareholders 1030 may be provided the option to receive REC distributions, or the equivalent cash market value of the RECs, or any combination thereof. A publicly traded investment fund 1010, such as an ETF, with holdings comprising a plurality of SPGCs 220a-n and/or Project Companies 1050a-n may thus provide investors easy access to a diversified sourcing of Guarantor positions, VPPA income and/or diversified sourcing of RECs.

In some embodiments, the investment fund 1010 may re-invest excess capital distributions into the underlying assets of the investment fund 1010. For example, the investment fund 1010 may hold excess capital and/or invest the excess capital to purchase additional shares of one or more SPGCs 220a-n and/or Project Companies 1050a-n or invest in shares of one or more new SPGCs 220a-n and/or Project Companies 1050a-n.

In some embodiments, the investment fund 1010 may select and hold a diverse range of SPGCs 220a-n and/or Project Companies 1050a-n. In some embodiments, an investment fund 1010 may select or hold or weight SPGCs 220a-n and/or Project Companies 1050a-n by market value. In some embodiments, an investment fund 1010 may select or hold or weight SPGCs 220a-n and/or Project Companies 1050a-n based on an underlying assets or other criteria, which may include, but are not limited to, one or more or any combination of the following: market capitalization, or credit risk, or ratio of capital or collateral to future potential VPPA power purchase obligations, or remaining duration of a relevant VPPA, or remaining duration of the company, or geographic location, or project type of VPPA, or power marketplace type, or anticipated growth in average electricity price in power market, or historic growth in average electricity price in power market, or spread between historic average electricity price in the power market and a Guaranteed Price of electricity in a relevant VPPA, or spread between predicted average electricity price in power market and the VPPA Guaranteed, or project type, or stage of project development, or cashflow distributions per shares or other unit of invested capital, or historic investment yield excluding excess capital distributions, or historic investment yield including excess capital distributions, or historic RECs yield, or future or forward predicted investment yield excluding excess capital distributions, or future or forward predicted investment yield including excess capital distribution, future or forward RECs yield, or developed economy region, or developing economy region, or electricity market dynamics, or VPPA type, or VPPA structure, or VPPA price. For example, the investment fund 1010 may invest in SPGCs 220a-n with a credit rating greater than or equal to AA and net positive income, excluding excess capital distributions, over a rolling 12-month period.

In some embodiments, other factors for evaluating an SPGC 220 or Project Company 1050, include, but are not limited to, one or more or any combination of the following: the RECs or other credits distributed per share, or the RECs or other credits distributed as a percentage yield, or the MWh of RECs distributed per $10,000 or other amount of invested shareholder capital, or the MWhs of RECs distributed per $10,000 or other amount of invested shareholder capital on a 12 month rolling average basis, or the predicted future MWhs of RECs distributed per $10,000 or other amount of invested shareholder capital on a quarterly or 12 month basis, or the MWhs of RECs distributed per a unit of invested shareholder capital over a desired historic time period, or the predicted future MWhs of RECs distributed per a unit of invested shareholder capital over a desired time period, or any combination thereof.

An investment fund 1010 may charge management fees or other fees, which may include, but are not limited to, one or more or any combination of the following: percentage of underlying assets, or percentage of cashflow distributions, or a percentage of settlement payments (e.g., distributions from net proceeds from the Marketplace Price of electricity sold and the VPPA Guaranteed Price) distributed by underlying shares of SPGCs 220a-n and/or Project Companies 1050a-n, or a percentage of RECs distributed by underlying shares of SPGCs 220a-n and/or Project Companies 1050a-n.

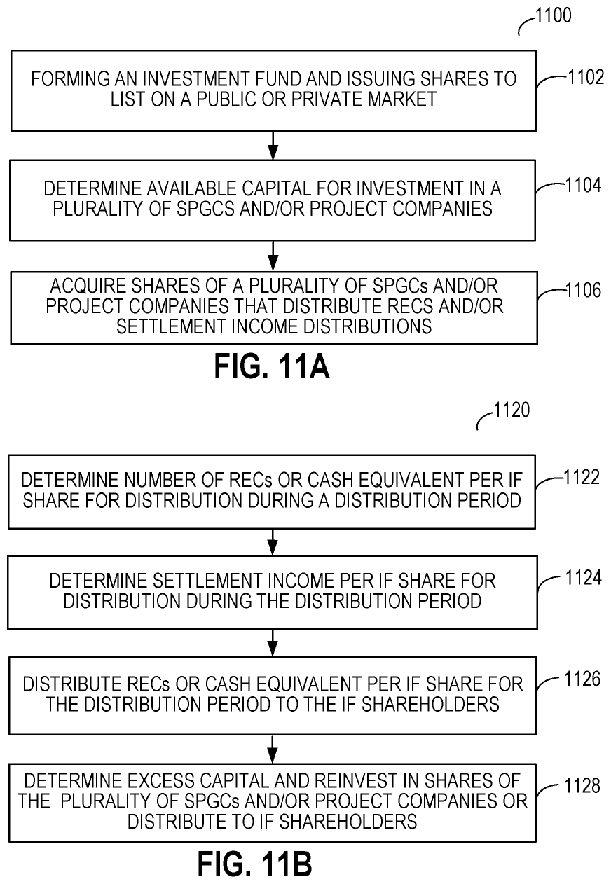

FIG. 11A depicts a flow chart of an exemplary method 1100 for formation of an investment fund 1010 in accordance with one or more embodiments herein. In some embodiments, an investment fund has shares in a plurality of SPGCs, which may provide diversification in the sourcing of RECs, and the settlement income distributions. One type of investment fund, a publicly traded ETF, with holdings of a plurality of SPGCs provides an easier method for smaller companies and individuals to invest in a diversified sourcing of income from VPPA settlement payments and/or diversified sourcing of RECs.

The investment fund 1010 is formed and shares are issued for sale on a public or private market at step 1102. For example, an ETF may issue shares and list the shares on a public financial exchange 510, such as the NYSE or NASDAQ. The raised capital from the sale of the shares is assessed to determine the available capital for investment at step 1104. The investment fund 1010 acquires and holds shares in a plurality of SPGCs 220 and/or Project Companies 1030 or other entities that distribute RECs and/or settlement income from VPPA agreements at step 1106. The shares in the plurality of SPGCs 220 and/or Project Companies 1030 include, e.g., common, or preferred stocks or securities.

FIG. 11B depicts a flow chart of an exemplary method 1120 for shareholder distributions by an investment fund 1010 in accordance with one or more embodiments herein. At periodic distribution periods, the investment fund 1010 distributes RECs or fractions thereof received by the investment fund 1010 as a shareholder in the plurality of SPGCs 220 and/or Project Companies at step 1122. The investment fund 1010 determines the total number of RECs received during the distribution period from the plurality of SPGCs 220 and/or Project Companies 1030 less any withholdings and divides by the number of outstanding investment fund shares. The RECs per IF share for distribution may be determined using the following calculation.

$$\frac{Total RECs from SPGCs or Project Companies - Withholdings}{Number of IF Shares Outstanding} = RECs per IF Share for Distribution$$

In some embodiments, the investment fund system 1020 may provide a digital notification to the IF shareholders of the transfer of RECs per IF share and total allocated RECs for each shareholder, such as through email, text, etc. The IF system 1020 may initiate transfers of title in the RECs with the tracking system 270 or another digital database. In some embodiments, the IF system 1020 may provide a centralized platform for REC management and REC compliance. In some embodiments, RECs may be tokenized. In some embodiments, the RECs may be transferred to the shareholder's accounts in one or more tracking systems 270 associated with each electricity grid operator system or Renewable Portfolio Standard (RPS) commodity market or compliance market of the RECs elected for distribution by the shareholder.

In some embodiments, one or more IF shareholders 1040a-n may elect to receive a cash distribution rather than RECs. The investment fund 1010 may sell the RECs (less any commissions, fees, costs, etc.) allocated for these shareholders and generate net proceeds per each sold REC. The cash distribution for the sold RECs may be determined, e.g., using the IF system 1020 from the following calculation.

(RECs per IF Share*Net Sale Proceeds per REC)=REC Net Proceeds per IF Share

In another example, in some embodiments, one or more IF shareholders 1040a-n may elect to have their RECs sold by the investment fund 1010 and receive the net proceeds from the sale at step 1108. The investment fund 1010 may arrange the sale of the RECs allocated to these IF shareholders, and e.g., the IF system 1020 may determine the proceeds from the sales of the RECs less any withholdings, such as fees, sales commissions, or costs of the sale to obtain the REC net proceeds. The cash distribution from the net proceeds of the sold RECs may be determined, using the following equation.

(RECs per IF Share*Net Proceeds per Sold REC)=REC Net Proceeds per IF Share

The REC net proceeds per IF share may be distributed to the shareholders electing for a cash distribution in accordance with the number of shares held by such shareholders at step 1112. For example, the investment fund system 1020 may provide a digital notification to the IF shareholders, such as email, text, etc., and initiate bank transfers for the cash distribution to the IF shareholders.

Additionally, and/or alternatively, the investment fund 1010 may distribute settlement income received during the distribution period as a shareholder of the plurality of SPGCs 220 at step 1124. The settlement income is generated by one or more of the plurality of SPGCs 220 from a positive net price difference between the Guaranteed Prices and the Market Prices in one or more VPPAs. The settlement income may be distributed to the investment fund 1010 as a shareholder of the one or more of the plurality of SPGCs 220.

For example, the IF system 1020 may determine the received settlement income for a distribution period and any withholdings due to costs, fees, etc. This net settlement income is then divided by the number of outstanding IF shares to obtain the net settlement income per IF share as shown below.

$$\frac{Settlement Income - Withholding}{Number of IF Shares Outstanding} = Settlement Income per IF share$$

The investment fund 1010 distributes this net settlement income originating from its portfolio of SPGC shares to the IF shareholders 1040 at step 1126. For example, the investment fund system 1020 may provide a digital notification to the IF shareholders 1040, such as email, text, etc., and initiate bank transfers to the IF shareholders.

The investment fund system 1020 may further determine and track excess capital distributions from the portfolio of SPGC shares at step 1128. In some embodiments, this received excess capital may be reinvested in the portfolio or basket of shares of the plurality of SPGCs 220 and/or Project Companies 1030. Alternatively, or additionally, this received excess capital may be distributed to the IF shareholders 1040.

The investment funds 1010, through ownership of multiple SPGCs, provide diversification in the sourcing of RECs, and the settlement income. Publicly traded ETFs with holdings comprising multiple SPGCs may provide investors easy access to ETF shares with a diversified sourcing of settlement income and/or diversified sourcing of RECs.

### Embodiment of a Shareholder Application System

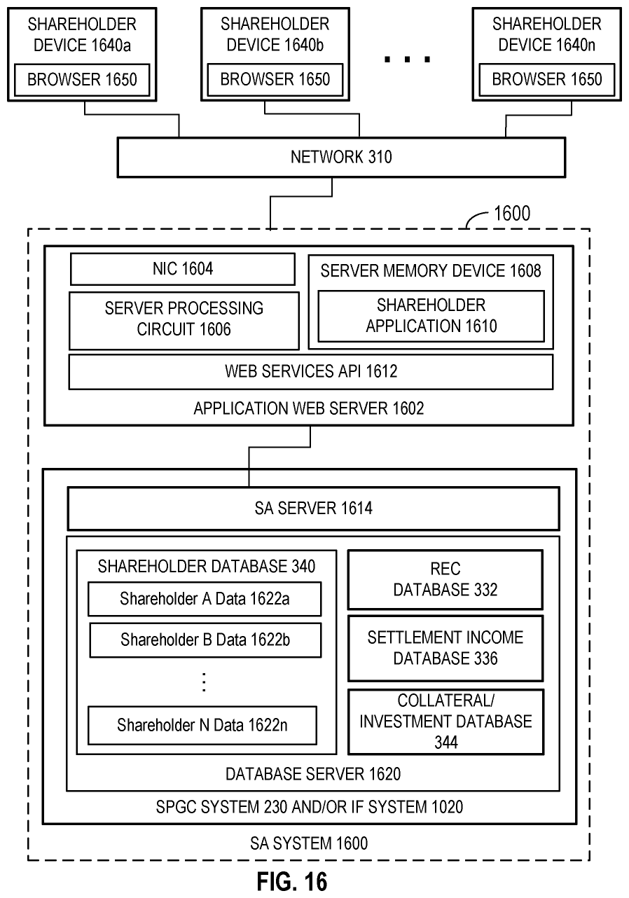

In some embodiments, the SPGC 220 and/or IF 1010 may provide a technically improved interface and system for managing shareholder accounts. For example, a web-based application and system may be implemented for managing individual shareholder accounts and/or for purchasing, selling, or trading shares of the SPGC 220 and/or the IF 1010. In an embodiment, the SPGC system 230 and/or the IF system 1020 may include and/or communicate with a web server that hosts and operates an Internet web-based application for secure access by SPGC and/or IF shareholders, referred to as a Shareholder Application System or SA System 1600 (as shown in more detail with respect to FIG. 16). The SA System 1600 may provide shareholders with a secure login to access shareholder information, such as REC and/or cash distributions to the shareholder, for a current distribution period or for past distribution periods. A shareholder may access data on a number of RECs received, number of shares owned, renewable energy facilities invested in, VPPA terms, capital holdings of the SPGC 220 or IF 1010, etc. The SA System 1600 may also provide a marketplace to buy and sell shares and/or RECs to account holders.

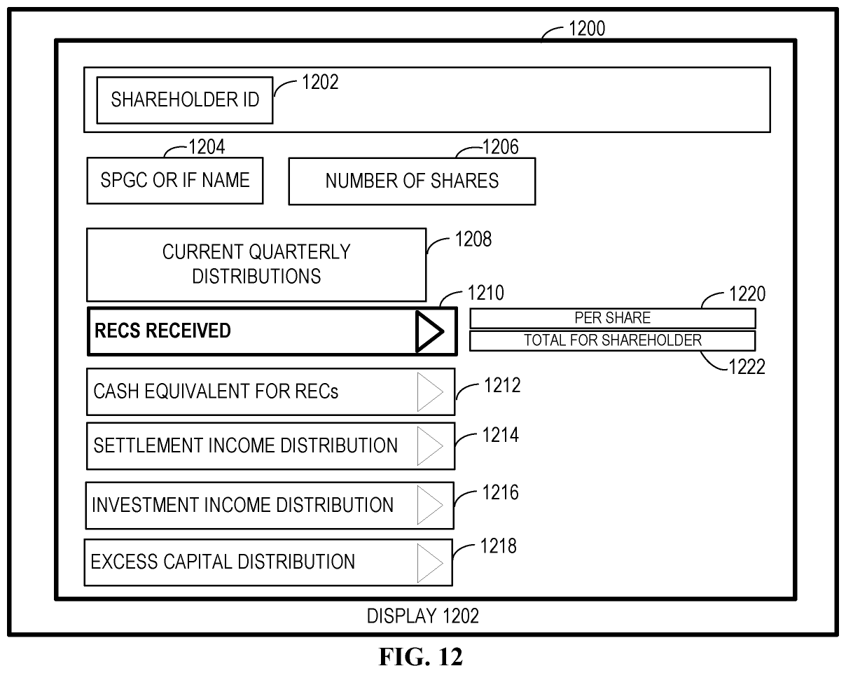

FIG. 12 illustrates a schematic block diagram of an exemplary graphical user interface (GUI) 1200 on a display 1202 in accordance with one or more embodiments herein. For example, the GUI 1200 may be generated by the SA System 1600 for transmittal to and display on a shareholder device 250a-n, e.g., after a secure login or other authentication to the SA System 1600. The GUI 1200 includes data fields, such as a shareholder ID 1202, name of the SPGC 220 or IF 1010, and/or a number of shares 1206 held by the shareholder. In this example, the GUI 1200 includes an icon for selection of current quarterly distributions 1208. When selected, the current quarterly distributions icon 1208 provides information or data on distributions to the shareholder for the most recent quarter or other distribution period, including REC distributions 1210, distributions of cash equivalent to RECs 1212, settlement income distributions, investment income distribution 1216, and excess capital distribution. The GUI 1200 may include icons to view the distributions per share 1220 or by a total for the shareholder 1222. These icons and menus are exemplary and alternate or additional GUIs may be implemented by the SA System 1600 to display similar or alternate or additional data to the shareholder.

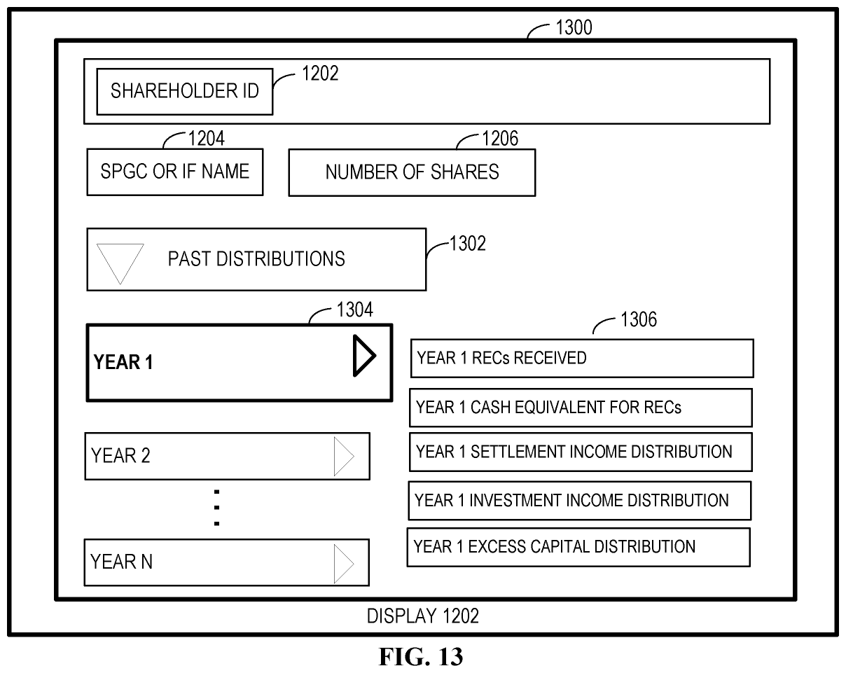

FIG. 13 illustrates a schematic block diagram of another exemplary GUI 1300 on a display 1202 in accordance with one or more embodiments herein. For example, the GUI 1300 may be generated by the SA System 1600 for transmittal to a browser on a shareholder device 250. The GUI 1300 illustrates a selectable drop-down menu 1302, or other interactive icon, for display of past distributions. The drop-down menu 1302 may display one or more year icons 1304 that may be selected to display information for that year. The displayed information 1306 for the selected year may include RECs and/or Cash Equivalent for RECs distributed to the shareholder. The displayed information 1306 may further include settlement income distribution, investment income distribution, and/or excess capital distribution to the shareholder.

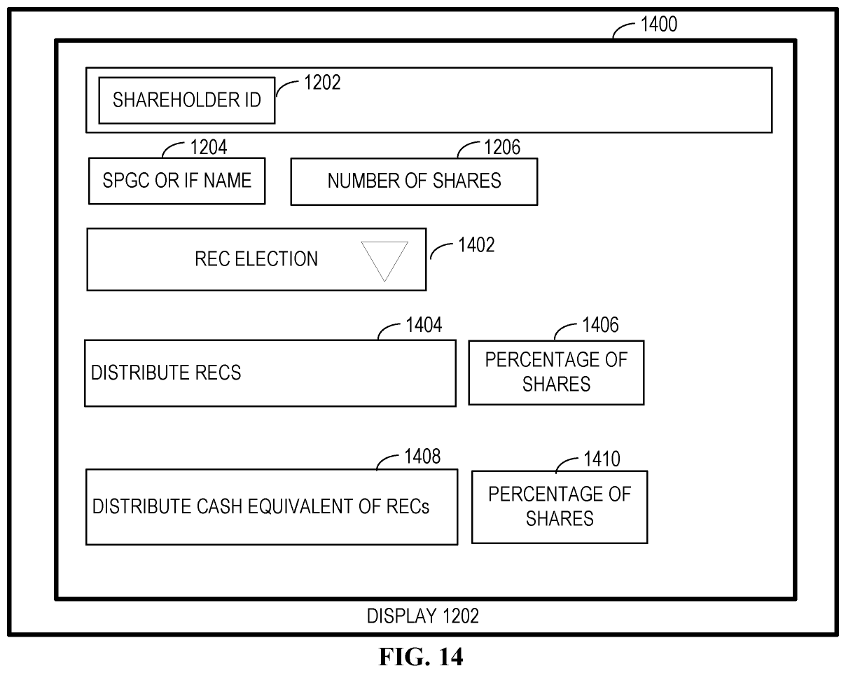

FIG. 14 illustrates a schematic block diagram of an exemplary GUI 1400 on a display 1202, such as on a SPGC shareholder device 250 or IF shareholder device 1040, in accordance with one or more embodiments herein. In this GUI 1400, a REC election icon 1402 generates a display of a first icon 1404 to select a distribution of RECs and a second icon 1408 to select a cash equivalent distribution of RECs. In some embodiments, both may be selected, and a percentage of shares selected for each option, e.g., using input or menu icons 1406 and 1410. For example, the shareholder may elect to receive RECs for 50% of their shares and receive Cash Equivalent of RECs for the other 50% of their shares. The shareholder may elect to receive RECs for 100% of their shares until certain renewable energy goals are met in a year. The shareholder may then elect to receive a cash equivalent for their allocated RECs for 100% of their shares. This function of allowing a selection of distributions of RECs and/or their cash equivalent provides greater flexibility to shareholders to meet their individual goals. The selection of the shareholder may be stored in the shareholder database of the SA System 1600.

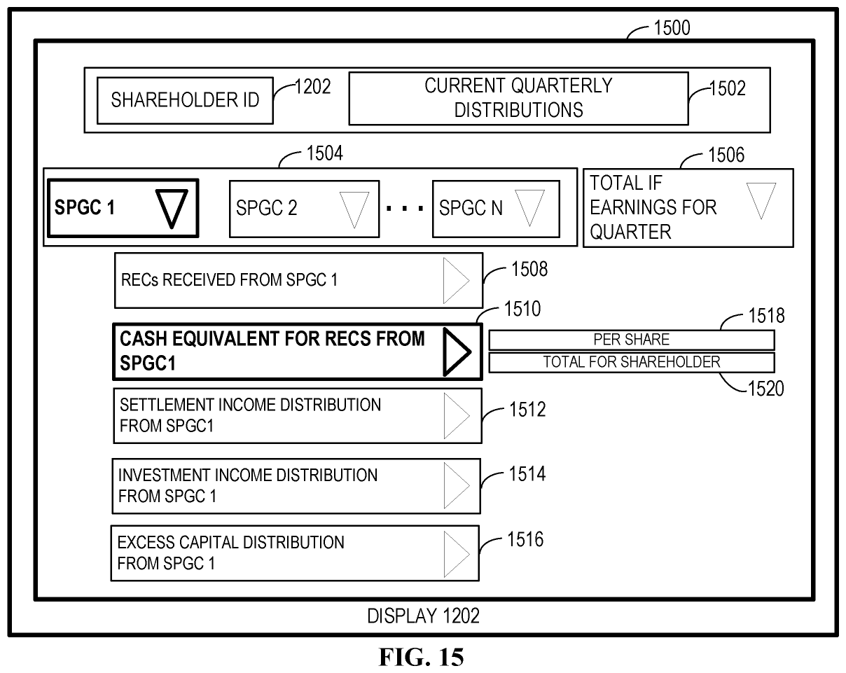

FIG. 15 illustrates a schematic block diagram of an exemplary GUI 1500 on a display 1202, such as on an IF shareholder device 1040, in accordance with one or more embodiments herein. In this GUI 1500, the current quarterly distributions icon 1502 is selected to provide information to an IF shareholder 1030 on their quarterly distributions from an investment fund 1010, wherein the investment fund 1010 holds shares in a plurality of SPGCs 220a-n. The GUI 1500 may include icons 1504 for selection of one or more of the plurality of SPGCs 220a-n. When an SPGC 220 is selected, distributions from the investment fund 1010 originating from the selected SPGC 220 may be displayed. For example, the information in the GUI 1500 for the selected SPGC 1 includes RECs received 1508, Cash equivalent for RECs 1510, settlement income distribution 1512 investment income distribution 1514, and excess capital distribution 1516. Distributions per IF share 1518 and/or total distributions for the shareholder 1520 may be displayed. An icon 1506 may be selected to view this information for the total IF distributions to the shareholder.

These various embodiments of the GUIs 1200, 1300, 1400, 1500 of the SA System 1600 are exemplary and additional and/or alternate GUIs may be generated by the SA System 1600 for an SPGC 220 or an investment fund 1010. The various GUIs of the SA System 1600 described herein may help shareholders to manage their accounts and provide price transparency and income transparency into VPPA contracts of the SPGCs 220 and investment funds 1010.

FIG. 16 is a schematic block diagram of an exemplary SA System 1600 in accordance with one or more embodiments herein. In some embodiments, the SA System 1600 includes at least one application web server 1602 that hosts a web based, shareholder application 1610. The application web server 1602 is configured to provide the shareholder application 1610 as a “Software as a Service” or SaaS system that allows access to the shareholder application 1610 online by the one or more shareholder devices 1640a-n. These shareholder devices 1640a-n may include devices of shareholders of an SPGC 220 and/or an investment fund 1010. The shareholder devices 1640a-n each may include any processing device, such as a smartphone, laptop, desktop, smart tablet, smart watch, etc., as shown in FIG. 4.

The shareholder devices 1640a-n each include a browser 1650 for communicating with the application web server 1602 over the network 310. For example, the web browsers 1650 allow the shareholder devices 1640a-n to interact with the web server 1602 via a Hypertext Transfer Protocol (“HTTP”) or other similar protocol. The web server 1602 may transmit GUIs as HTML files or as other types of files and/or transmit other data or content to the browsers 1650 or performs other functions.

The network 310 includes a combination of one or more networks that communicatively couple the SA System 1600 and the shareholder devices 1640a-n, and may include, e.g., a wide area network (WAN) or a wireless wide area network (Wireless WAN). The WAN includes the Internet, service provider network, other type of WAN, or a combination of one or more thereof. The Wireless WAN includes a cellular network, such as a 4G or 5G or 6G cellular network. The WAN or Wireless WAN may be communicatively coupled directly to a shareholder device 1640a-n or coupled to a shareholder device 1640a-n through an edge network, e.g., including a router, bridge (not shown), and/or through a WLAN access point (AP). A shareholder device 1640a-n may be coupled to a private local area network (LAN), including e.g., a wired LAN and/or a WLAN access point. Alternate networks and/or methods of communicating information may be substituted without departing from the scope hereof.

The application web server 1602 includes, e.g., a network interface card (NIC) 1604 that includes a transceiver for wireless and/or wired network communications with one or more of the shareholder devices 1640a-n over the network 310. The NIC 1604 may also include authentication capability that requires an authentication process prior to allowing access to some or all of the resources of the application web server 1602, such as a login with a username and password, biometric identification, or other verification process. The NIC 1604 may also include firewall, gateway, and proxy server functions.

The application web server 1602 also includes a server processing circuit 1606 and a server memory device 1608. For example, the server memory device 1608 is a non-transitory, processor readable medium that stores computer-executable instructions which when executed by the server processing circuit 1606, causes the SA System 1600 to perform one or more functions described herein. Computer-executable instructions may include, e.g., program modules such as routines, programs, objects, components, data structures, etc. that perform particular tasks or implement particular abstract data types. In the case of program code execution on programmable computers, the interface unit generally includes a processor, a storage medium readable by the processor (including volatile and non-volatile memory and/or storage elements), at least one input device, and at least one output device. Such programs may be implemented in a high-level procedural or object-oriented programming language to communicate with a computer system. However, the program(s) can be implemented in assembly or machine language, if desired. In any case, the language may be a compiled or interpreted language, and combined with hardware implementations. The server memory device 1608 may store one or more operations or routines or other instructions of the SA application 1610.

The application web server 1602 communicates over a private network with the SA Server 1614, e.g., such as a server 330, 1022 in the SPGC system 230 and/or the IF system 1020. The database server 1620 stores one or more databases, such as the shareholder database 340, REC database 332, settlement income database 336, and the collateral/investment database 344. The shareholder database 340 may include information or data for a plurality of shareholders in shareholder data folders 1622a-n. The shareholder database 340 may be used to track and manage shareholder information or data, such as names, addresses, emails, number of shares, elections for distributions of RECs or cash equivalents, etc. When the SPGC or IF shares are listed and sold using a financial exchange system 350, the SA System 1600 may communicate with the exchange system 350 to obtain shareholder data.

Though shown as separate databases, two or more of the databases may be stored in a single database or in alternate or additional databases or in a same or separate servers. As may be appreciated, the databases may be any appropriate database capable of storing data, including without limitation cloud-based databases, and may be included within or connected to one or more servers similar to those described herein in any appropriate manner without departing from the scope hereof. The database server 1620 may include RAM, ROM, electrically erasable programmable read-only memory (“EEPROM”), flash memory or other memory technology, CD-ROM, digital versatile disks (“DVD”) or other optical storage, magnetic cassettes, magnetic tape, magnetic disk storage or other magnetic storage devices, cloud devices, or any other medium which can be used to store the desired information and can accessed by the SPGC server 330.

This tiered architecture is more secure as the shareholder devices 1640a-n do not directly access the data in the data server 1620. The web services API 1612 provides an interface for communication between the application web server 1602 and the SPGC Server 330. The SPGC server 330 may then access any requested data in the database server 1620 and provide the requested data to the application web server 1602, e.g., for communication to the shareholder devices. The SA System 1600 provides a special purpose computing system configured for provision of the new methods and functions described herein. The SA System 1600 includes significant additional elements with tangible physical form and provides a practical application for performing one or more unique methods described herein that may only practically be performed by a computing system, considering the multitude of data, e.g., of the plurality of shareholders, of the shares, etc., complex analysis, and the generation of computer implemented interfaces with new functionality, and communications with remote, third party processing devices.

The servers, memory devices, and databases shown in FIG. 16 are merely exemplary, and servers and/or databases may be omitted, added, or substituted without departing from the scope of the present invention. In addition, different system architectures may be implemented that perform the functions described herein.

### REC Management Platform

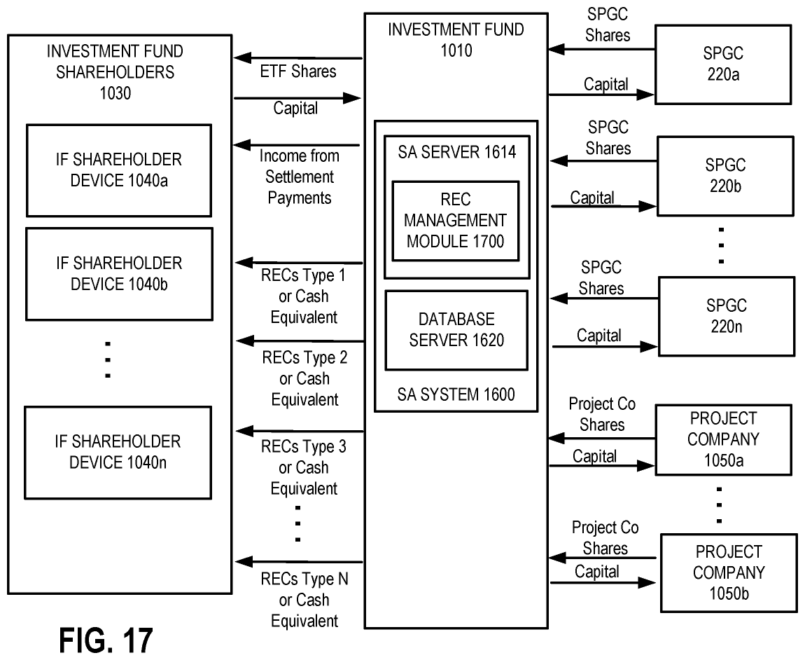

FIG. 17 depicts a schematic block diagram of another exemplary system for an investment fund (IF) 1010 in accordance with one or more embodiments herein. In some embodiments, an investment fund 1010 and/or other type of Exchange Traded Fund (ETF) may hold shares of one or more SPGCs 220, wherein the one or more SPGCs 220 are Guarantors in VPPAs with one or more renewable energy projects in multiple geographies, or electricity markets, or electricity grids, or any combination thereof. Each underlying renewable energy project may produce different types of RECs, in different geographies and at varying times. As such, in some embodiments, an investment fund 1010 may receive and distribute RECs with different data attributes, e.g., RECs generated from different geographic regions, at different times of day and/or days of week, or at different carbon intensities of electricity consumed at the time of day or having other different attributes. A shareholder 1030 in an investment fund 1010 may elect to receive distributions of certain types of RECs, and/or may elect to receive the proceeds of sale or cash value distribution of other types of RECs. For example, a shareholder 1010, which may be, for example, a retail electricity provider or a large electricity consumer, may elect to receive direct distributions of RECs from New York Independent System Operator (NYISO), NY's power grid operator, or from PJM Environmental Information Services (PJM EIS), an REC market provider. However, the shareholder may elect to not receive RECs, but rather a cash equivalent distribution of the RECs, from the California Independent System Operator (CAISO) or from Electric Reliability Council of Texas (ERCOT).

As shown in FIG. 17, the IF shareholder devices 1040a-n may elect to receive one or more types 1-N of RECs or their cash equivalents. For example, a shareholder 1030, which may be, for example, a retail electricity provider or an electricity consumer, may elect to receive direct distributions of RECs issued at specific hours on specific dates in specific geographic regions, and receive the cash equivalent distribution of RECs issued at other hours and/or dates and/or geographic regions. For example, a shareholder, which may be, for example, a retail electricity provider or an electricity consumer, may elect to receive direct distributions of RECs from specific projects, and receive the cash equivalent distribution of RECs from other projects.

In some electricity markets, electricity grid operators and regulators require electricity customers to procure or otherwise obtain a certain quantity of RECs for each MWh of electric power consumed. In some electricity markets, the RECs procured by electricity consumers must be generated at the same time as their electricity was consumed, or from projects located within the same state or regional electricity grid, or from projects within the same electricity market, or within the same geographic region, or within a certain distance from the electricity consumption, or any combination thereof. In some markets, the complexity of REC mandates may be even greater, with mandates to match the carbon intensity of electricity consumed at the time of day and region of electricity consumed with the carbon intensity of electricity available on the grid when the obtained RECs were generated, which may be designed to ensure RECs procured displace CO₂ emissions associated with the production of electricity consumed by the electricity consumer.

The supply and demand for RECs may vary widely by electricity market or region, due to various factors, which may include, but are not limited to, local renewable energy standards or mandates, or constraints or limitations in constructing new projects, or increasing demand for electricity, or changing composition of electricity sources on an electricity grid. And so, the demand for RECs may also depend on the electricity market or region of the issued RECs.

To meet the complex REC mandates and varying supply and demands, electricity consumers and electricity providers must search for and purchase RECs matching their electricity consumption, including, in some markets, the time of the electricity consumed. In some instances, RECs available for sale may not match the RECs required to match the consumer's electricity consumption, and, in some instances, the electricity consumer must purchase non-compliant RECs, which may be subject to various adjustment factors, and/or wherein adjustment factors may change with time of day, geography, and changes in regulations or market rules & regulations. The process of procuring RECs can be inefficient, human intensive, computationally intensive, and prone to error. REC procurements may be avoided by entering VPPAs with renewable energy projects in a desired geographic region to receive RECs generated from the geographically needed project, however this option is limited to large, high credit rated corporations with the financial strength and long-term forecasts capable of committing to the liability and long-term commitment of a VPPA. In addition, some electricity consumers may need RECs from projects in multiple geographic regions.

In some embodiments, a system for an SPGC 220 and/or an investment fund 1010 may provide a centralized platform for REC management and/or REC compliance, e.g., such as an REC management module 1700 shown in FIG. 17. The REC management module 1700 may include the SA server 1614 (shown in FIG. 16) with a server processing circuit 1606 and a server memory device 1608 that stores computer-executable instructions which when executed by the server processing circuit 1606, causes the SA System 1600 to perform one or more functions described herein with respect to the REC management module 1700. In some embodiments, the computerized REC management module 1700 provides one or more of filtering, or electing, or customizing, or recommending REC distribution preferences. In some embodiments, the REC management module 1700 may include a function to provide the shareholder estimates of REC distributions, which includes providing an estimate for a number of RECs or number of RECs per share in future distributions, e.g., using information on the size of the shareholder's position, or the number of shares held by the shareholder, or the REC elections provided by the shareholder, or other information, or any combination thereof. In some embodiments, the REC management module 1700 may generate and/or utilize projections for project specific power production to calculate estimates or predictions or ranges for the number of RECs to be distributed by an SPGC 220 and/or investment fund 1010 or to provide recommendations to the shareholder for a size of their position, and REC elections to reach their REC requirements or REC goals.

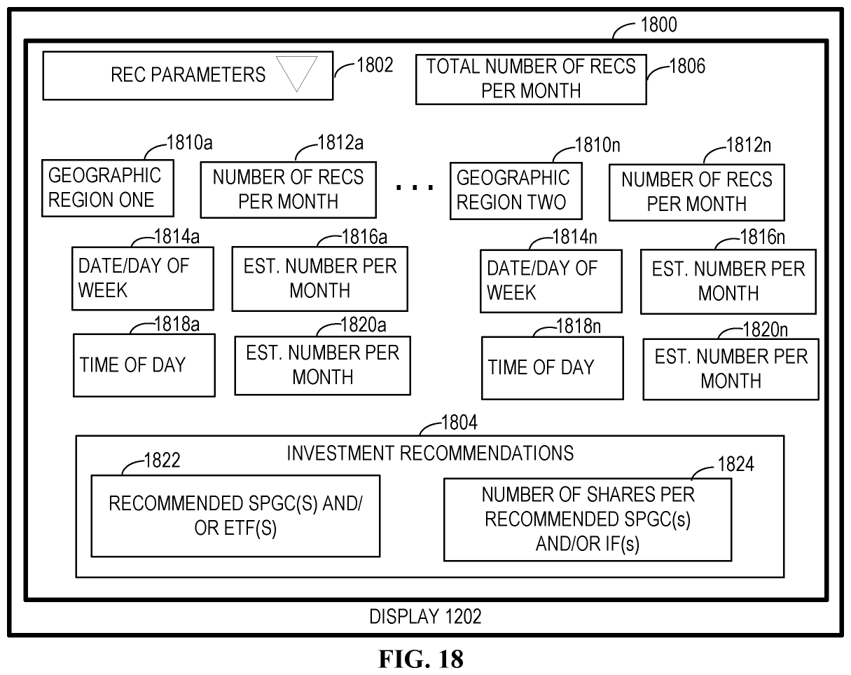

FIG. 18 illustrates a schematic block diagram of an exemplary GUI 1800 on a display 1202, such as on a SPGC shareholder device 250 or an IF shareholder device 1040, in accordance with one or more embodiments herein. In some embodiments, the REC management module 1700 assists in generating one or more GUIs 1800 to receive one or more REC related parameters 1802 from the shareholder and/or potential shareholder relating to their REC requirements or goals. The REC management module 1700 may then determine and display investment recommendations 1804 to meet the defined REC parameters 1802.

For example, the REC parameters 1802 may include a total number of RECs 1806 requested or needed per month, per quarter, per year or other period of time. When particular data attributes of the RECs are needed, the GUI 1800 may include user inputs to specify one or more such data attributes, such as geographic regions 1810a-n and the number of RECs 1812a-n needed or requested per geographic region 1810a-n e.g., per month, per quarter, per year, or other time period. The geographic regions 1810a-n may be defined by country, state, county, city, zip code, utility grid region (such as CAISO, NYISO, ERCOT, etc.) or other defined geographic regions. For each geographic region 1810a-n, the GUI 1800 may include user inputs for a number of RECs 1816a-n needed for each geographic region or for one or more specific dates or for certain days of the week 1814a-n or for months or other periods of time. For example, a shareholder may have higher electricity use and RCE demands for summer months or winter months and so includes different estimates of needed RCEs for the different time periods. The GUI 1800 may then include inputs for a number of RECs 1820a-n needed for one or more different times of day 1818a-n. The number of RECs 1806, 1812, 1816, 1820 may be estimated numbers to reach certain goals or legal requirements of the shareholder.

The GUI 1800 may further display investment recommendations 1804 that identify one or more SPGCs 220 and/or investment funds 1010 and/or a size of a position (e.g., number or percentage of shares) and/or REC elections to reach the REC requirements or goals. The REC parameters may include a number ofRECs needed from one or more geographic regions, and for each geographic region, the RECs needed for the defined dates, day of weeks, times of day for a particular date or day of the week.

For example, a shareholder may need a predetermined goal number of RECs in only one geographic location. So, using a shareholder device 1640, the predetermined goal number of RECs per month 1812a are input into the GUI 1800 for one geographic region 1810a. The REC management module 1700 may then determine one or more SPGCs 220 and/or one or more investment funds 1010 that receive or distribute to shareholders RECs meeting the input REC parameters, e.g., RECs issued in the input one or more geographic regions. The REC management module 1700 may then display the identified SPGCs and/or investments funds 1010 1822 in the GUI 1800. The REC management module 1700 may also determine a stock position 1824, e.g., such as a number or percentage of shares, needed in the one or more SPGCs 220 and/or investment funds 1010 to obtain the predetermined goal number of RECs in the input geographic location and displays this result 1824 in the GUI 1800.

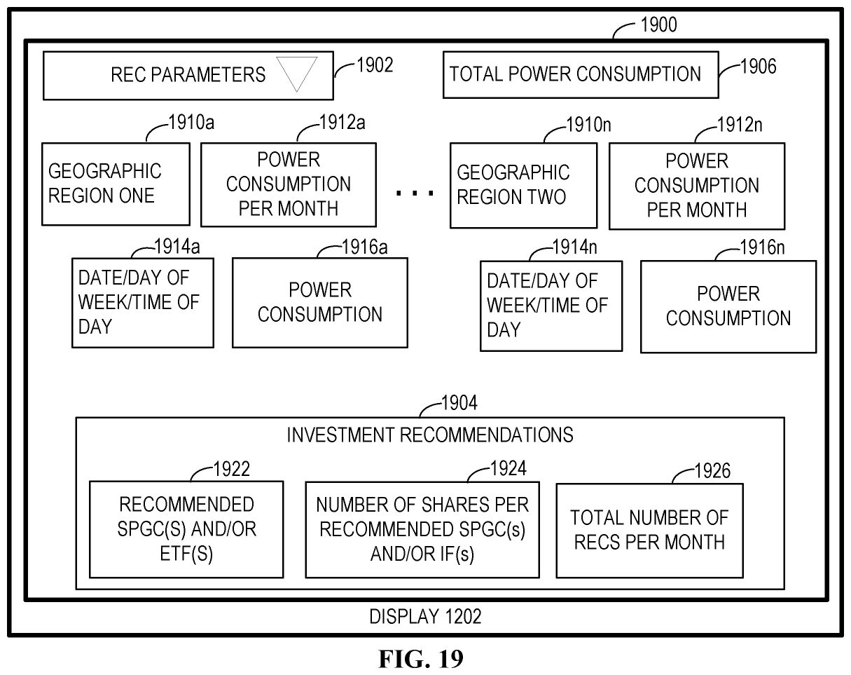

FIG. 19 illustrates a schematic block diagram of another exemplary GUI 1900 on a display 1202, such as on a SPGC shareholder device 250 or an IF shareholder device 1040, in accordance with one or more embodiments herein. In some embodiments, the REC parameters 1902 may include a total power consumption 1906 per month, per quarter, per year, or other period of time. The GUI 1900 may also include inputs for power consumption 1912a-n for one or more geographic regions 1910a-n and/or power consumption 1916a-n for a time of day, for a day of week or specific dates, months, or other periods of time.

In some embodiments, based on the input power consumptions, the REC management module 1700 determines a number of RECs and REC data attributes required to meet one or more legal requirements and/or shareholder REC goals. For example, in some embodiments, the REC management module 1700 determines a legally required number of RECs for an identified geographical location using the information of the shareholder's power consumption, or the shareholder's power consumption time-of-day, or the shareholder's power consumption locations, or other information, or any combination thereof. In another example, in some embodiments, the REC management module 1700 determines a number of RECs to meet a shareholder's goals using information on the shareholder's power consumption, or the shareholder's power consumption time-of-day, or the shareholder's power consumption locations, or other information, or any combination thereof.

The REC management module 1700 may then determine one or more SPGCs 220 and/or one or more investment funds 1010 that receive the determined RECs meeting the input parameters, e.g., RECs issued in the input one or more geographic regions, and at the input day and/or time of day. The REC management module 1700 may then display the results 1922 in the GUI 1900. The REC management module 1700 may also determine a share position 1924, e.g., such as a number or percentage of shares, needed in the one or more SPGCs 220 and/or investment funds 1010 to obtain the predetermined goal number of the RECs per month 1926 in the input geographic location.

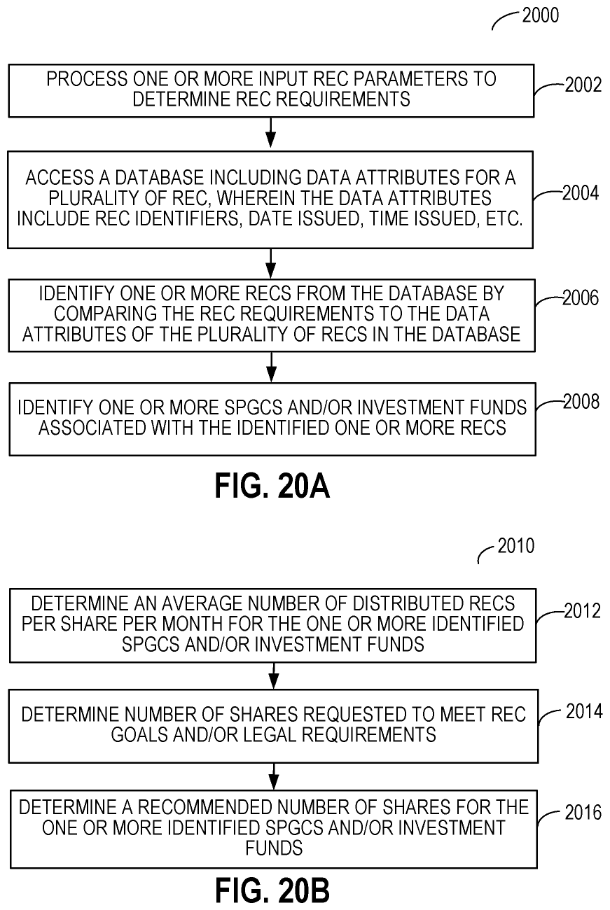

FIG. 20A illustrates a flow chart of an exemplary method 2000 for identification of RECs using input REC parameters in accordance with one or more embodiments herein. In some embodiments, the REC management module 1700 obtains the one or more input REC parameters 1802,1902, e.g., through one or more GUIs, and processes the one or more input REC parameters to determine REC requirements at step 2002. For example, when the REC parameters include power consumption in a geographical territory, the REC management module 1700 may determine the legal requirements for RECs in the geographical territory, such as required number of RECs, geographical location of required RECs, time of day or dates of the required RECs, etc. In another embodiment, the REC management module 1700 determines REC requirements based on shareholder's goals, such as carbon neutrality goals.

The REC management module 1700 then accesses one or more databases storing REC data attributes of a plurality of RECs including, e.g., REC unique identifier, certificate type, tracking system ID, renewable fuel type, renewable facility location, nameplate capacity of project, project name, emissions rate of the renewable resource, date issued, time issued, or other attributes at step 2004. The REC management module 1700 may compare the determined REC requirements to the data attributes in the database and identify one or more RECs with one or more matching or similar data attributes at step 2006. The REC management module 1700 may then identify one or more SPGCs 220 and/or investment funds 1010 that received or owned the RECs and/or distributed the RECs to its shareholders at step 2008. The REC management module 1700 may then generate a GUI to display the one or more SPGCs 220 and/or investment funds 1010 to a shareholder.

FIG. 20B illustrates a flow chart of an exemplary method 2010 for determination of a share position in accordance with one or more embodiments herein. In some embodiments, the REC management module 1700 determines a recommended share position, e.g., such as a recommended number or percentage of shares, needed in the identified one or more SPGCs 220 and/or one or more investment funds 1010 to obtain the required number of RECs per month (or per other time period). At step 2012, the REC management module 1700 determines an average or mean number of distributed RECs per share per month (or per quarter or per year) of the one or more identified RECs. Historical data may be used in the determination or published share information from the identified one or more SPGCs 220 or investment funds 1010 may be used in the determination. Data relating to past, present or future production of a renewable energy facility may also be used. For example, an SPGC 220 may distribute a historical average of 0.012 RECs per share per month of an identified REC. When 48 RECs per month are requested or needed, then the REC management module 1700 may determine the recommended number of shares is at least 4,000, e.g., using the following calculation.

$$\frac{Average \frac{RECs}{Share} Distributed per Month}{Number of RECs requested per Month} = Recommended Number of Shares$$

The percentage share position may be determined by dividing the recommended number of shares by the total outstanding shares for the identified SPGC 220 and/or investment fund 1010.

When multiple SPGCs 220 and/or investment funds 1010 are identified, the REC management module 1700 may determine the recommended number of shares for each using additional considerations such as share price for each of the SPGCs 220 and/or investment funds 1010, overall cost to obtain the needed number of RECs, reliability of distribution of RECs/share, desire for diversification, projections of future distributions, etc.

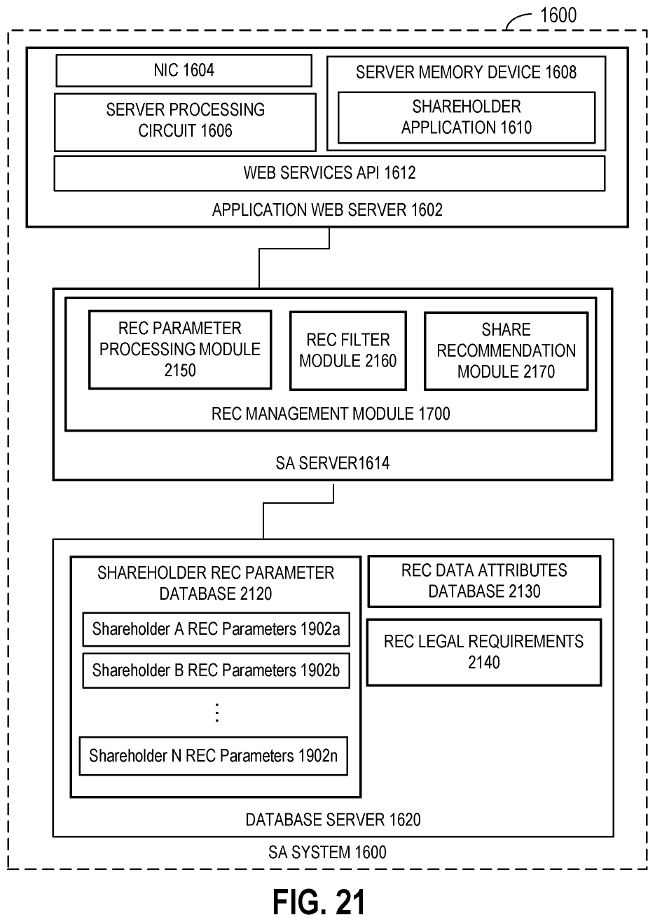

FIG. 21 depicts a schematic block diagram of an exemplary REC management module 1700 implemented in the shareholder application (“SA”) system 1600 in accordance with one or more embodiments herein. The SA System 1600 includes, e.g., a database server 1620 or one or more other memory device(s), that stores a shareholder REC parameter database 2120. The REC parameter database 2120 includes the REC parameters 1902a-n input by a plurality of shareholders. The REC parameters may include one or more of geographical location of RECs, dates/days of weeks, time of day, months of the year, or other time periods of issuance of the RECs, power consumption of the shareholder, power consumption by geographical location, power consumption during a time period, such as date, day of week, month, etc., power consumption at a time of day, etc. The SA system 1600 includes, e.g., a database server 1620 or one or more other memory device(s), that stores REC data attributes database 2130 that stores the data attributes of a plurality of RECs and the SPGC 220 or investment fund 1010 owning or distributing the RECs. The SA system 1600 may further include a database that stores REC legal requirements for one or more geographical locations.

The REC management module 1700 may include an REC parameter processing module 2150 that processes the REC parameters 1902a-n to determine REC requirements, e.g., a number of RECs based on power consumption, legal requirements, shareholder goals, etc. The REC filter module 2160 may determine one or more issued RECs with same or similar REC data attributes as the determined REC requirements or parameters. The REC filter module 2160 may also identify the one or more SPGCs 220 and/or investment funds 1010 that own or distributed the identified RECs. The share recommendation module 2170 may determine a recommendation of a share position for the identified one or more SPGCs 220 and/or investment funds 1010.

The REC management module 1700 may greatly reduce the inefficiency, human intensity, computational intensity, and error risk of REC compliance, for example, for electricity consumers and electricity providers. For example, in some embodiments, electricity consumers and/or electricity providers may comprise shareholders of SPGCs 220 or investment funds 1010 that receive RECs from renewable energy projects located in the electricity markets or regions where the electricity consumer and/or electricity provider operates or otherwise needs RECs. For example, in some embodiments, electricity consumers and/or electricity providers may comprise shareholders of an investment fund 1010 investing in a plurality of SPGCs 220a-n or other project companies 1050a-n, wherein the electricity consumer or electricity provider may elect for receiving distributions of different types of RECs, e.g., based on geographic region, time of day, dates, etc. The REC management module 1700 may identify one or more SPGCs 220 and/or investment funds 1010 distributing RECs needed or requested using one or more data inputs by the electricity consumer and/or electricity provider. A share position of the identified one or more SPGCs 220 and/or investment funds 1010 may also be determined using share prices, number of shares needed to obtain REC requirements, diversification requirements, historical reliability of distribution of RECs per share, etc. The REC management module 1700 may thus assist small or large companies to determine and meet their REC goals or requirements.

As described herein, in one or more embodiments, a renewable energy facility produces electricity using a renewable energy source. In other embodiments, an energy facility may be implemented that includes a non-renewable energy source or a combination of renewable and non-renewable energy sources. For example, an energy facility in one or more embodiments herein may use one or more or any combination of the following: solar, or solar PV, or solar thermal, or wind, or onshore wind, or offshore wind, or hydro, or hydropower plant, or geothermal, or geothermal power, or geothermal heat, or geothermal cooling, or nuclear power generation, or nuclear heat generation, or nuclear cooling, or waste heat power generation, or waste heat recovery, or combined heat and power, or combined cooling and power, or wave power, or ocean thermal energy conversion (“OTEC”), or biomass power, or waste incineration power generation, or municipal solid waste power generation, or mixed waste power generation, or renewable natural gas power generation, or biogas power generation, or natural gas power generation, or diesel power generation, or oil power generation, or liquified petroleum gas (“LPG”) power generation, or hydrocarbon power generation, or sulphur combustion power generation, or coal power generation, or petroleum-coke power generation, or plastic waste power generation, or electrochemical power generation, or osmotic power generation, or mixing power generation, or power generation from temperature differences, or power generation from temperature changes, or thermal power generation, or light based power generation, or chemical power generation, or parasitic power generation, or some combination thereof.

The embodiments of the SPGCs 220 and investment funds 1010 provide significant advantages over the currently known VPPA arrangements. The shares of the SPGCs 220 and the investments funds 1010 are transferable, tradeable, and exchangeable. In some embodiments, the shares, or ownership interests, or any combination thereof of the SPGC may be transferrable, or tradable, or exchangeable, or any combination thereof. In some embodiments, the shares, or ownership interests, or any combination thereof of an SPGC may be traded on a public stock exchange, or other public secondary market. The shares, or ownership interests, or any combination thereof of an SPGC may be transferrable, or tradable, or exchangeable, or any combination thereof, and/or the shares, or ownership interests, or any combination thereof of an SPGC 220 may be traded on a public stock exchange, or other public secondary market because, for example, the credit rating or credit risk of the SPGC 220 as a Guarantor may be independent of or unrelated to the credit rating or credit risk of the SPGC's shareholders. The credit rating or credit risk of an SPGC 220 as Guarantor is independent of or unrelated to the credit rating or credit risk of the SPGC's shareholders because the SPGC 220 may be required to hold sufficient capital or collateral to cover the cost of the Guarantor obligations in a VPPA and/or the SPGC 220 itself may be responsible for covering the cost of the Guarantor obligations in a VPPA. The shareholders of the SPGC 220 may be directly or indirectly isolated from responsibility or liability for the Guarantor obligations of the SPGC 220.

In another advantage, the shares of the SPGCs 220 and/or the investments funds 1010 provide liquidity, price transparency, and market efficiency in VPPAs and the Guarantor position. The liquidity of the shares may enable a company or person to receive the benefits of the Guarantor position, such as meeting renewable energy goals, and/or potential income, and/or electricity price hedge, while enabling flexibility and avoiding long term commitments, liability, high upfront cost, high management cost, and power purchase obligations typically associated with the Guarantor position in a VPPA. Additionally, the share price and/or share price performance of an SPGC or an SPGC ETF in a liquid market may provide new information, including insight into inflation expectations, or the anticipated future price of electricity, or power market dynamics, or any combination thereof.

In another advantage, the shares of the investments funds 1010 provide diversification through ownership of shares of a plurality of SPGCs 220. The investment fund 1010 provides diversification in the sourcing of RECs, and the sourcing income, which may comprise income from the spread between market price and VPPA price. In specific, publicly traded ETFs with holdings comprising multiple SPGCs 220 may provide investors easy access to a diversified sourcing of Power Price Guarantor position VPPA income and/or diversified sourcing of RECs.

In yet another advantage, the SPGCs 220 and/or the investments funds 1010 increase the number of possible Guarantors to fund VPPA for renewable energy projects. The SPGCs 220 and/or the investments funds 1010 may enable renewable energy project developers and/or renewable energy project owners to secure a high credit rating Guarantor for a VPPA, while avoiding the hassle of finding and convincing large creditworthy corporations and institutions to be a Guarantor. For example, SPGCs 220 may be formed as needed, providing significant creditworthy competition to large corporations and institutions in the Guarantor market and/or potentially improving the terms, or duration of, VPPAs, which may benefit renewable energy project developers and/or facilitate the deployment of renewable energy projects. Few corporations or institutions have perfect or near perfect credit ratings. SPGCs 220 may be formed to provide a perfect or near perfect credit rating Guarantor as needed, which may expand the available supply of perfect or near perfect credit rating Guarantors. This increased number of possible Guarantors may enable renewable energy project developers to secure a lower cost of financing, or a lower interest rate on debt, or better financing terms, or any combination thereof, which may reduce the required VPPA power price, or the levelized cost of energy from renewable energy project, or any combination thereof, which may facilitate increased building of renewable energy infrastructures and/or increase the affordability and/or reliability of electricity and/or increase the SPGC's income from electricity sales. Because SPGCs 220 may be formed as needed, SPGCs 220 may seize potential significant dislocations between the Guaranteed price and average market price of electricity, which may exist due to a limited supply or constrained supply of large, creditworthy corporations or institutions with willingness to enter VPPAs as a Guarantor.

### SPGCs for Other Industries

The embodiments described herein may be applicable to commodities other than, or in addition to, electricity, which may include, but are not limited to, carbon dioxide, or pipeline carbon dioxide, or natural gas, or renewable natural gas, or biogas, or landfill gas, or hydrogen, or hydrogen derivative, or liquid air, or oxygen, or nitrogen, or argon, or sulphur, or fertilizer, or ammonia, or hydrocarbons, or LPG, or agricultural commodities, or wood, or pipeline capacity, or electric grid capacity, or power capacity, or vehicle capacity, or transportation capacity, or renewable energy credits, or renewable energy certificates, or compliance certifications, or renewable portfolio standard certificates, or biofuel, or renewable fuel standard credits, or Renewable Identification Numbers (RINs), or metals, or ores, or carbon credits, or carbon offsets, or water, or oil, or coal, or biomass, or recyclables, or trash, or landfill gas, or municipal solid waste, or cement, or green cement, or steel, or metals, or sand, or plastic, or aggregates, or asphalt, or steam, or heat, or district heating, or cold, or district cooling, or hot water, or cold water, or chilled water, or computational power, or computational output, or light, or time, or land, or leases, or real estate, or cellular networks, or communication networks, or wireless networks, or wired networks, or bandwidth, or cable bandwidth, or network bandwidth, or advertising, or online advertising, or digital advertising, or physical advertising, or airplanes, or vessels, or vehicles, or loans, or any combination thereof.

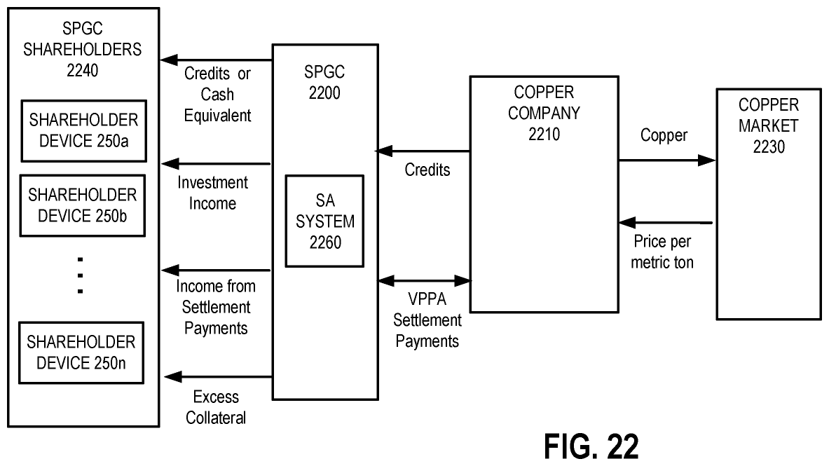

FIG. 22 illustrates an embodiment of an SPGC 2200 for investing in the production, or manufacture, or distribution, or infrastructure of copper. In one or more embodiments herein, a Special Purpose Guarantor Company (“SPGC”) 2200 is formed that includes a corporation, company, or other legal entity that functions or acts as a Guarantor of a Guaranteed Price of future copper mined and/or smelted by the copper company 2210 and sold on the copper market 2230. The SPGC 2200 issues a plurality of shares that may be publicly listed on a stock exchange or on a private exchange. The SPGC 2200 may hold capital or collateral sufficient to cover the cost of the potential future obligations as a Guarantor of a Guaranteed price (e.g., such as price per ton of copper) with the Copper Company 2210. The SPGC 220 may generate income from the spread between the Market Price of copper sold by the copper company 2210 and the Guaranteed Price of the copper.

For example, some embodiments may relate to the construction of a copper mining and smelting integrated facility project by the copper company 2210. The copper project may require significant capital to construct. For example, the copper project may cost $1 billion to construct. To enable the financing and construction of the copper project, the copper company 2210 may desire a guaranteed a fixed price or a contracted price to reduce market price risk and enable financing for the project. In some embodiments, the fixed price may be less than the prevailing market price or expected future market price for copper, however it may provide the price stability and credit risk profile to enable financing and construct of the project. The guaranteed price may be for a sufficient duration to enable financing of the project and may be, for example, greater than or equal to one or more or any combination of the following: 3 years, or 5 years, or 10 years, or 15 years, or 20 years, or 25 years, or 30 years, or 35 years, or 40 years, or 45 years, or 50 years.

The SPGC 2200 may be formed and issue shares to investors to raise sufficient capital as collateral for future potential copper price guarantor obligations. In some embodiments, investors may invest in shares of the SPGC 2200 for, including, but not limited to, one or more or any combination of the following: provide exposure to the copper prices while simultaneously receiving interest income, or invest in copper while simultaneously receiving interest income, or invest in copper, or hedge copper prices, or inflation hedge, hedging the price of copper, or investing with the view that copper prices will go up, or an investment providing full exposure to the price of copper while also providing potential current cash interest rate income.

The SPGC 2200 may enter an agreement with the copper company 2210 to guarantee the price of future produced copper from the project for a duration (the virtual power purchase agreement or “VPPA”). The agreement may settle at set periods or settlement dates, and/or may include the average market price of copper sold during the settlement period. The SPGC 2200 may distribute price guarantor settlement income and/or excess capital to shareholders 2240.

In some embodiments, certificates or credits may be generated by the copper project for the associated copper production, and/or may be distributed by the SPGC 2210 to shareholders or may be sold and then the proceeds distributed to shareholders, or any combination thereof. In some embodiments, the copper company 2210 may produce certificates or credits because, for example, including but not limited to: the copper project may be more eco-friendly, or may produce less environmental waste, or may have better labor practices, or may meet certain ESG criteria, or may be located in a geopolitically favored country or region, or any combination thereof.

An SA system 2260 may include similar architecture, servers, memory devices, databases, modules, software to perform similar functions as described herein with respect to the SA system 1600 and REC management module 1700. An investment fund, such as an exchange traded fund, may be formed to purchase shares of a plurality of SPGCs 2200 investing in the copper or other industry. This investment fund may have similar systems, functions and embodiments as described with respect to the investment fund 1010 described herein. In other embodiments, an SPGC or exchange traded fund, as described herein, may be formed to invest in other industry projects besides copper, such as, for example, lithium, or lithium extraction, or lithium mining, or lithium processing, or lithium production, nickel, or nickel extraction, or nickel mining, or nickel processing, or nickel production or other metal, ore, or natural occurring substance.

The benefits, advantages and solutions to problems described herein with regard to one or more embodiments are merely exemplary and are not required or exclusive. Any benefit, advantage, solution to a problem, or any element that may cause any particular benefit, advantage, or solution to occur or to become more pronounced are not to be construed as critical, required, or essential features or components of any or all embodiments in the claims.

Although several processes have been disclosed herein as software, it may be appreciated by one of skill in the art that the same processes, functions, etc. may be performed via hardware or a combination of hardware and software. Similarly, although the present embodiments may have been depicted as a hardwired system, these concepts may be applied to wireless systems and hybrid hardwired and wireless systems without departing from the scope of the present invention.

Some embodiments are described herein as a process that is depicted as a schematic, a flowchart, a flow diagram, a structure diagram, or a block diagram. Although a flowchart may describe the operations as a sequential process, the operations may be performed in parallel or concurrently. In addition, the order of the steps or operations may be re-arranged, and steps or operations may be combined or additional and/or alternate steps included. The described methods or process may correspond to a method, a function, a procedure, a subroutine, a subprogram, etc.

Reference to an element in the singular is not intended to mean “one and only one” unless specifically so stated, but rather “one or more.” As used herein, the terms “comprise,” “comprises,” “comprising,” “having,” “including,” “includes” or any variation thereof, are intended to reference a nonexclusive inclusion, such that a process, method, article, composition or apparatus that comprises a list of elements does not include only those elements recited, but may also include other elements not expressly listed or inherent to such process, method, article, composition, or apparatus.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A method of a computing system for an investment company, comprising:
processing shareholder information stored in at least one system memory device of the computing system to determine a number of shares of the investment company, wherein the investment company acts a guarantor of a guaranteed price per power unit of renewable energy produced by a third party renewable energy facility;
determining, by the computing system, settlement income for the settlement period, by using a number of a plurality of power units produced by the renewable energy facility during the settlement period, the guaranteed price for the plurality of power units of renewable energy, and a market price received by the renewable energy facility for the plurality of power units,
determining, by the computing system, a per share distribution of the settlement income by using the determined settlement income and the number of shares of the investment company, and
determining, by the computing system, a shareholder distribution of the settlement income for a first one of the plurality of shareholders using a total number of shares owned by the first one of the plurality of shareholders and the per share distribution of the settlement income.

2. The method of the computing system of claim 1, further comprising:
determining, by the computing system, investment income generated during a distribution period, wherein the investment income is generated from one or more investments of capital of the investment company, and
determining, by the computing system, a per share distribution of the investment income using the determined investment income and the number of shares of the investment company.

3. The method of the computing system of claim 1, further comprising:
determining a number of power units produced and delivered to the electrical grid by the renewable energy facility during the settlement period
determining an average market price per power unit obtained by the renewable energy facility for the number of power units, and
when the average market price per power unit is greater than the guaranteed price per power unit, determining a settlement payment from the renewable energy facility, wherein the settlement payment from the renewable energy facility is determined from a difference between the average market price per power unit and the guaranteed price per power unit and the number of power units produced and delivered to the electrical grid by the renewable energy facility during the settlement period.

4. The method of the computing system of claim 3, further comprising:
when the average market price per power unit is less than the guaranteed price per power unit, determining a settlement payment to the renewable energy facility, wherein the settlement payment to the renewable energy facility is determined from a difference between the guaranteed price per power unit and the market price per power unit and the number of power units produced and delivered to the electrical grid by the renewable energy facility during the settlement period.

5. The method of the computing system of claim 4, further comprising:
determining, by the computing system, allocated capital for the settlement period, wherein the allocated capital is held as collateral for the guaranteed price for the plurality of power units of renewable energy produced for the settlement period,
determining, by the computing system, whether there is an excess portion of the allocated capital for the settlement period, wherein the excess portion is determined from a difference in the allocated capital for the settlement period and the settlement payment to the renewable energy facility for the settlement period, and
when there is an excess portion of the allocated capital for the settlement period, determining, by the computing system, the shareholder distribution of the excess portion of the allocated capital for the settlement period.

6. The method of the computing system of claim 1,
determining, by the computing system, a total number of renewable energy credits (RECs) obtained during a settlement period from the renewable energy facility, wherein each REC is generated for one power unit produced and delivered to an electrical grid by the renewable energy facility; and
determining, by the computing system, the shareholder distribution of the total number of RECs to the plurality of shareholders.

7. The method of the computing system of claim 6, wherein the determining, by the computing system, the shareholder distribution of the total number of RECs, comprises:
obtaining, by the computing system, a first election by a first one of a plurality of shareholders to receive RECs as the shareholder distribution from the investment company,
determining a number of REC(s) for distribution to the first one of the plurality of shareholders by using the total number of RECs, a total number of the plurality of shares, and a number of shares owned by the first one of the plurality of shareholders.
determining, by the computing system, a second election by a second one of the plurality of shareholders to receive a cash distribution for the RECs as the shareholder distribution from the investment company,
determining a number of REC(s) allocated for distribution to the second one of the plurality of shareholders using the total number of RECs, the total number of the plurality of shares, and the number of shares owned by the second one of the plurality of shareholders,
determining a price per REC obtained by the investment company, and
determining the cash distribution to the second one of the plurality of shareholders.

8. The method of the computing system of claim 7, further comprising:
generating, by the computing system, a graphical user interface (GUI) for display including one or more user inputs for electing to receive RECs as the shareholder distribution from the investment company or to receive a cash distribution for the RECs as the shareholder distribution from the investment company.

9. The method of the computing system of claim 1, wherein a majority of the capital of the investment company is collateral for future potential payment obligations due to a difference in the guaranteed price and a predetermined floor price for a predicted number of power units of renewable energy to be produced by the renewable energy facility during a predetermined term.

10. A computing system of a guarantor company, comprising:
at least one system memory; and
at least one processing unit, wherein the processing unit is operatively coupled to the at least one system memory and wherein the at least one system memory stores instructions that, when executed by the at least one processing unit, configures the computing system to:
determine a total number of renewable energy credits (RECs) obtained by the guarantor company during a settlement period from a renewable energy facility, wherein each REC is generated for one power unit produced and delivered to an electrical grid by the renewable energy facility;
generate a graphical user interface (GUI) for display on one or more shareholder devices, wherein the GUI includes at least one user input configured to set a shareholder preference to receive RECs as shareholder distribution from the guarantor company or to receive a cash distribution for the RECs as the shareholder distribution from the guarantor company;
obtain from a first shareholder device a first election by one of a plurality of shareholders to receive RECs as the shareholder distribution from the investment company;
determine a number of REC(s) allocated for distribution to the one of the plurality of shareholders using the total number of RECs, a total number of a plurality of shares of the guarantor company, and a number of shares owned by the one of the plurality of shareholders;
obtain from a second shareholder a second election by a second one of the plurality of shareholders to receive a cash distribution for the RECs as the shareholder distribution from the investment company; and
determine the cash distribution for the RECs to the second one of the plurality of shareholders using a price per REC and a number of REC(s) allocated for distribution to the second one of the plurality of shareholders.

11. The computing system of claim 10, wherein the computing system further comprises:
at least one transceiver configured to communicate with a financial exchange system over a wide area network; and
wherein the computing system is further configured to obtain, from the financial exchange system, shareholder information for the plurality of shareholders holding at least one share of the plurality of shares of the guarantor company; and
process the shareholder information for storage in a shareholder database in the at least one system memory.

12. The computing system of claim 10, wherein the computing system is further configured to:
determine investment income generated during a distribution period, wherein the investment income is generated from one or more investments of capital of the guarantor company; and
determine a shareholder distribution of the investment income using the determined investment income and the total number of the plurality of shares of the guarantor company.

13. The computing system of claim 10, wherein the computing system is further configured to:
determine a number of power units produced and delivered to the electrical grid by the renewable energy facility during the settlement period;
determine an average market price per power unit obtained by the renewable energy facility for the number of power units; and
when the average market price per power unit is greater than the guaranteed price per power unit, determine a settlement payment from the renewable energy facility to the guarantor company, wherein the settlement payment from the renewable energy facility is determined from a difference between the average market price per power unit and the guaranteed price per power unit and the number of power units produced and delivered to the electrical grid by the renewable energy facility during the settlement period.

14. The computing system of claim 13, wherein the computing system is further configured to:
determine settlement income of the guarantor company generated by the settlement payment from the renewable energy facility; and
determine a shareholder distribution of the settlement income using the determined settlement income and the total number of a plurality of shares of the guarantor company.

15. The computing system of claim 10, wherein the computing system is further configured to:
determine a number of power units produced and delivered to the electrical grid by the renewable energy facility during the settlement period;
determine an average market price per power unit obtained by the renewable energy facility for the number of power units; and
when the average market price per power unit is less than the guaranteed price per power unit, determine a settlement payment to the renewable energy facility, wherein the settlement payment to the renewable energy facility is determined from a difference between the guaranteed price per power unit and the market price per power unit and the number of power units produced and delivered to the electrical grid by the renewable energy facility during the settlement period.

16. The computing system of claim 14, wherein the computing system is further configured to:
determine allocated capital for the settlement period, wherein the allocated capital is held as collateral for the guaranteed price for the plurality of power units of renewable energy produced for the settlement period;
determine whether there is an excess portion of the allocated capital for the settlement period, wherein the excess portion is determined from a difference in the allocated capital for the settlement period and the settlement payment to the renewable energy facility for the settlement period; and
when there is an excess portion of the allocated capital for the settlement period, determine a shareholder distribution of the excess portion of the allocated capital for the settlement period.

17. A method of a computing system for an exchange traded fund (ETF), comprising:
determining, by the computing system, a total number of shares for each of a plurality of guarantor companies that are held by the ETF, wherein a majority of the assets of the ETF include the shares for each of the plurality of guarantor companies;
determining, by the computing system, a total number of renewable energy credits (RECs) obtained by the ETF as shareholder distributions from the plurality of guarantor companies, wherein each REC is generated for one power unit produced and delivered to an electrical grid by a renewable energy facility;
determining, by the computing system, a plurality of shareholders of the ETF by accessing a shareholder database in at least one system memory device of the computing system;
generating, by the computing system, a graphical user interface (GUI) for display on one or more shareholder devices, wherein the GUI includes at least one user input for selecting at least one of a plurality of elections, wherein the plurality of elections includes at least a first election for receiving RECs as shareholder distribution from the guarantor company and a second election for receiving a cash distribution for the RECs as the shareholder distribution from the guarantor company;
processing, by the computing system, a first election received from a browser of a first shareholder device and store the first election in a first data field associated with a first one of the plurality of shareholders in the shareholder database;
determining, by the computing system, a number of REC(s) allocated for distribution to the first one of the plurality of shareholders using at least the total number of RECs, a total number of shares of the ETF, and a number of shares owned by the first one of the plurality of shareholders; and
in response to the first election, generating, by the computing system, a distribution of the number of REC(s) allocated for distribution to the one of the plurality of shareholders.

18. The method of the computing system of claim 17, comprising:
processing, by the computing system, a second election received from a browser of a second shareholder device and store the second election in a second data field associated with a second one of the plurality of shareholders in the shareholder database; and
determining, by the computing system, a number of REC(s) allocated for distribution to the second one of the plurality of shareholders using at least the total number of RECs, a total number of shares of the ETF, and a number of shares owned by the second one of the plurality of shareholders; and
determine the cash distribution for the RECs to the second one of the plurality of shareholders using a price per REC and the number of REC(s) allocated for distribution to the second one of the plurality of shareholders.

19. The method of the computing system of claim 17, comprising:
processing, by the computing system, shareholder information transmitted to a transceiver of the computing system from an exchange system and storing the processed shareholder information in the shareholder database in the at least one system memory device of the computing system.

20. The method of the computing system of claim 17, further comprising:
determining, by the computing system, settlement income for the settlement period obtained by the ETF as shareholder distributions from the plurality of guarantor companies; and
determining a settlement income distribution to each of the plurality of shareholders in the ETF using the determined settlement income and a total number of a plurality of shares of the ETF.

17. A method of a computing system for an exchange traded fund (ETF), comprising:
determining, by the computing system, a total number of shares for each of a plurality of guarantor companies that are held by the ETF, wherein a majority of the assets of the ETF include the shares for each of the plurality of guarantor companies;
determining, by the computing system, a total number of renewable energy credits (RECs) obtained by the ETF as shareholder distributions from the plurality of guarantor companies, wherein each REC is generated for one power unit produced and delivered to an electrical grid by a renewable energy facility,
determining, by the computing system, a plurality of shareholders of the ETF by accessing a shareholder database in at least one system memory device of the computing system,
generating, by the computing system, a graphical user interface (GUI) for display on one or more shareholder devices, wherein the GUI includes at least one user input for selecting at least one of a plurality of elections, wherein the plurality of elections includes at least a first election for receiving RECs as shareholder distribution from the guarantor company and a second election for receiving a cash distribution for the RECs as the shareholder distribution from the guarantor company,
processing, by the computing system, a first election received from a browser of a first shareholder device and store the first election in a first data field associated with a first one of the plurality of shareholders in the shareholder database,
determining, by the computing system, a number of REC(s) allocated for distribution to the first one of the plurality of shareholders using at least the total number of RECs, a total number of shares of the ETF, and a number of shares owned by the first one of the plurality of shareholders, and
in response to the first election, generating, by the computing system, a distribution of the number of REC(s) allocated for distribution to the one of the plurality of shareholders.

18. The method of the computing system of claim 17, comprising:
processing, by the computing system, a second election received from a browser of a second shareholder device and store the second election in a second data field associated with a second one of the plurality of shareholders in the shareholder database, and
determining, by the computing system, a number of REC(s) allocated for distribution to the second one of the plurality of shareholders using at least the total number of RECs, a total number of shares of the ETF, and a number of shares owned by the second one of the plurality of shareholders; and
determine the cash distribution for the RECs to the second one of the plurality of shareholders using a price per REC and the number of REC(s) allocated for distribution to the second one of the plurality of shareholders.

19. The method of the computing system of claim 17, comprising:
processing, by the computing system, shareholder information transmitted to a transceiver of the computing system from an exchange system and storing the processed shareholder information in the shareholder database in the at least one system memory device of the computing system.

20. The method of the computing system of claim 17, further comprising:
determining, by the computing system, settlement income for the settlement period obtained by the ETF as shareholder distributions from the plurality of guarantor companies, and
determining a settlement income distribution to each of the plurality of shareholders in the ETF using the determined settlement income and a total number of a plurality of shares of the ETF.
